(19) United States
(12) Patent Application Publication
(10) Pub. No.: US 2010/0163076 A1
(43) Pub. Date: Jul. 1, 2010

(54) Method for Machine-Washing Dishes

(76) Inventors: Johannes Zipfel, Dusseldorf (DE); Nadine Warkotsch, Dusseldorf (DE); Arnd Kessler, Monheim am Rhein (DE); Christian Nitsch, Dusseldorf (DE)

Correspondence Address: Henkel Corporation, 10 Finderne Avenue, Bridgewater, NJ, 08807, US

(21) Appl. No.: 12/721,031

(22) Filed: Mar. 10, 2010

Related U.S. Application Data
(63) Continuation of application No. PCT/EP2008/061902, filed on Sep. 9, 2008.

(30) Foreign Application Priority Data
Sep. 10, 2007 (DE) 102007042857.1

(51) Int. Cl. A47L 15/42; B67D 7/00; C11D 3/386

(52) U.S. Cl. 134/25.2; 222/52; 510/226

(57) ABSTRACT

Method for machine-washing dishes comprising at least one wash or rinse cycle wherein the dishes are washed in each wash or rinse cycle with an aqueous washing liquor that, for multiple wash or rinse cycles, is at least partially replaced between wash or rinse cycles, wherein
a) at time t₁ a preparation A containing a protease and optionally a further enzyme, an enzyme stabilizer, a polymer, a bleach activator, and/or a bleach catalyst,
b) at time t₂ a preparation B containing an alkalizing agent and optionally a complexing agent and/or a polymer, and
c) at time t₃ a preparation C containing a bleaching agent and optionally a non-aqueous solvent, a bleach activator, and/or a bleach catalyst,
   are added to at least one washing liquor, preparations A, B and C differing from one another in composition, at least one of preparations A, B and C containing a surfactant, at least one of preparations A and B being liquid and at least one washing liquor containing for at least part of the time both protease and bleaching agent.

### CROSS REFERENCE TO RELATED APPLICATIONS

The present application is a continuation of International Patent Application No. PCT/EP2008/061902 filed 9 Sep. 2008, which claims priority to German Patent Application No. 10 2007 042 857.1 filed 10 Sep. 2007, both of which are incorporated herein by reference.

The present patent application relates to automatic dishwashing and describes methods for machine-washing of dishes and agents for use in such methods.

Dishwashing agents are available to the consumer in many different forms. In addition to traditional liquid hand dishwashing agents, automatic dishwashing agents have become highly important due to the growing use of automatic dishwashers. These automatic dishwashing agents are typically made available to consumers in solid form such as powders or tablets, but increasingly also in liquid form.

One of the principal objectives of automatic dishwashing agent manufacturers is to improve the cleaning performance of these agents, with greater emphasis focused on cleaning performance in low-temperature wash cycles, as well as in wash cycles with reduced water consumption. With this in mind, preferably novel ingredients, for example, more active surfactants, polymers or bleaching agents, have been added to the cleaning agents. As these novel ingredients are available only to a limited extent, and as the added amount of ingredient per cleaning cycle can not be increased above a certain amount due to environmental and economic grounds, this approach has only limited possibilities.

Use of enzymes for improving washing and cleaning performance in automatic dishwashing has been established in the prior art for some time. In particular, hydrolytic enzymes such as proteases and amylases are ingredients in many dishwashing agents.

Bleaching agents are often used in automatic dishwashing in order to obtain spotless dishes. To activate these bleaching agents and achieve an improved bleaching action when cleaning at temperatures of 60° C. and below, automatic dishwashing agents generally also contain bleach activators or bleach catalysts, with bleach catalysts being especially effective. There are, however, limits to the use of these bleaching agents due to their incompatibility with other active washing or cleaning ingredients such as enzymes, or due to stability problems in storing cleaning agents containing bleaching agents. This applies also to liquid cleaning agents.

The damaging effect of bleaching agents on enzymes such as proteases (which are especially important for automatic dishwashing) frequently leads to unsatisfactory results in conventional dishwashing methods if both protein-based stains and bleachable stains, particularly tea stains, are to be removed effectively.

There has therefore been no shortage of attempts to keep enzymes and bleaching agents separate from one another, not only in storage of corresponding cleaning agents but also during the cleaning method. The latter is generally difficult to achieve, however. Even if enzymes and bleaching agents are dosed in separate wash cycles as in the case of a multi-cycle cleaning method, the partial entrainment of washing liquors generally occurs, meaning that enzyme and bleaching agent come into contact with one another, potentially interacting with one another disadvantageously.

In recent times product developers have begun to turn their attention to devices for multiple dosing of cleaning agents. Here, a distinction can be made between dosing containers integrated into the dishwashing machine and standalone devices which are independent from the dishwashing machine. With these devices, which can contain multiple doses of cleaning agent necessary for performing one cycle of a cleaning method, portions of cleaning agent are dosed by automatic or semi-automatic means into the inside of the dishwashing machine during the course of several successive cleaning methods. For the consumer, this eliminates the need to keep adding the necessary quantity of cleaning agent before each cleaning cycle. Examples of such devices are described in European patent application EP 1759624 A2 and German patent application DE 102005062479 A1. Such devices described in the prior art are not completely satisfactory, however. For example, they are limited with respect to dosing of preparations in differing states of aggregation, as well as dosing of several different partial preparations, which lead to a satisfactory cleaning result only in their entirety, at different points during the course of the cleaning method. However, a particular problem with these devices is the manner in which the constituents or partial preparations of the cleaning agent are added during the cleaning process, frequently leading to unsatisfactory cleaning results. In particular, achieving good cleaning results on both protein-based and bleachable stains such as tea stains has proven to be problematic.

Against this technical background, the present invention provides a method for machine-washing dishes, as well as agents for performing such a method which, even in low-temperature wash cycles or in wash cycles with low water consumption, offer good cleaning performance, for example, on stubborn, dried-on stains, and particularly good removal of both protein-based and bleachable stains even when enzymes, in particular protease, and bleaching agents come into contact with each other during the course of the cleaning method via a washing liquor.

This method was achieved by a method for machine-washing dishes comprising contacting the dishes in a wash or rinse cycle with at least one aqueous washing liquor, wherein there is at least one wash or rinse cycle. When there is more than one wash or rinse cycle, the at least one washing liquor is at least partially replaced between the wash or rinse cycle. A preparation A is added to the at least one washing liquor at a time t₁, preparation A having at least one protease and optionally at least one further enzyme, at least one enzyme stabilizer, at least one polymer, at least one bleach activator, and/or at least one bleach catalyst. A preparation B is added to the at least one washing liquor at a time t₂, preparation B having at least one alkalizing agent and optionally at least one complexing agent and/or at least one polymer. A preparation C is added to the at least one washing liquor at a time t₃, preparation C having at least one bleaching agent and optionally at least one non-aqueous solvent, at least one bleach activator, and/or at least one bleach catalyst. Preparations A, B and C differ from one another in composition, wherein at least one of preparations A, B and C contain at least one surfactant, at least one of preparations A and B is liquid, and at least one washing liquor contains for at least part of the time both protease and bleaching agent. The invention also provides for a combination product comprising a packaging and the three preparations A, B and C contained separately from one another in the packaging.

The present application thus provides firstly a method for the machine-washing of dishes comprising at least one wash or rinse cycle, the dishes being brought into contact in each wash or rinse cycle with an aqueous washing liquor and in the case of multiple wash or rinse cycles the washing liquor being at least partially replaced between the wash or rinse cycles, wherein

a) at a time t₁ a preparation A, which contains at least one protease and optionally
a. at least one further enzyme, in particular at least one amylase, and/or
b. at least one enzyme stabilizer and/or
c. at least one polymer and/or
d. at least one bleach activator and/or
e. at least one bleach catalyst,

b) at a time t₂ a preparation B, which contains at least one alkalizing agent and optionally
a. at least one complexing agent and/or
b. at least one polymer,

and

c) at a time t₃ a preparation C, which contains at least one bleaching agent and optionally
a. at least one non-aqueous solvent and/or
b. at least one bleach activator and/or
c. at least one bleach catalyst,

are added to at least one washing liquor,

preparations A, B and C differing from one another in their compositions, at least one of preparations A, B and C containing at least one surfactant, at least one of preparations A and B being liquid and at least one washing liquor containing for at least part of the time both protease and bleaching agent.

Surprisingly, it has been found that outstanding removal of bleachable stains and simultaneous improved removal of protein-based stains can be achieved through the method according to the invention. This is completely unexpected, since according to the teaching of the prior art the use of bleaching agents usually reduces the protease performance.

Methods for machine-washing dishes generally comprise more than one wash or rinse cycle, for example, a prewash cycle and a main wash cycle and a rinse cycle, with washing liquor being used in each of these wash or rinse cycles. When a wash or rinse cycle is ended, the liquor used therein is generally more or less completely pumped out, with the technical equipment of the machine determining the maximum extent to which it is pumped out. Then a new washing liquor and fresh water are used for the next wash or rinse cycle. An intermediate rinse cycle can also occur between the prewash and the main wash cycle. When the liquors are changed, however, a partial entrainment of the washing liquor from the preceding to the subsequent wash or rinse cycle generally occurs.

Preparation a preferably contains at least one surfactant, in particular at least one non-ionic surfactant.

The at least one protease is contained in preparation A in a quantity of, for example, about 0.01 to about 20, preferably about 0.05 to about 15 and in particular about 0.1 to about 10 wt. %, based on total weight of preparation A.

To produce preparation A the protease is preferably used in the form of an enzyme preparation which in addition to the enzyme contains for example enzyme stabilizers, water and/or non-aqueous solvents. Such an enzyme preparation is preferably contained in preparation A in a quantity of about 0.1 to about 50 wt. %.

Further components optionally included in preparation A such as enzymes, in particular amylases, enzyme stabilizers, polymers, bleach activators and bleach catalysts, are described in more detail below.

In preferred embodiments of the invention, preparation A contains at least one further enzyme, in particular at least one amylase, and/or at least one enzyme stabilizer.

Preparation A preferably contains no bleaching agent.

At least one alkalizing agent is contained in preparation B in a quantity of, for example, about 3 to about 70, preferably about 5 to about 40 and in particular about 10 to about 30 wt. %, based on total weight of preparation B.

Other components optionally included in preparation B such as complexing agents and polymers are described in more detail below.

In a preferred embodiment of the invention preparation B additionally contains at least one complexing agent, for example, in a quantity of about 0.1 to about 70, preferably about 5 to about 45 and in particular about 10 to about 20 wt. %. It is self-evident that the quantities of the various substances contained in the preparation, such as alkalizing agents and complexing agents, must be adjusted to one another such that a total of 100 wt. % is not exceeded.

In a further preferred embodiment of the invention preparation B additionally contains water in a quantity of, for example, about 0.1 to about 80, preferably about 10 to about 75, particularly preferably about 25 to about 70, and in particular about 40 to about 60 wt. %.

Preparation C contains bleaching agent in a quantity of, for example, about 1 to about 95, preferably about 5 to about 80 and in particular, about 20 to about 50 wt. %.

Other components optionally included in preparation C such as non-aqueous solvents, bleach activators and bleach catalysts are described in more detail below.

All substances contained in preparation C in addition to the at least one bleaching agent should be selected such that they are adequately stable in respect of said bleaching agent and that no undesired interactions occur. Thus substances which are susceptible to oxidation, such as ethanol or n-propanol, are self-evidently not preferred as constituent(s) of the preparation.

Preparation C can contain water, preferably in a quantity of less than about 10, in particular less than about 5 wt. %. In a further preferred embodiment of the invention preparation C is substantially free from water.

Preparation C preferably contains no enzyme.

In a preferred embodiment of the invention, the method is executed in such a way that t₁=t₂=t₃, meaning that preparations A, B and C are added to the washing liquor simultaneously.

It can further be preferred if at least two of the three times t₁, t₂ and t₃ differ from one another.

In a further embodiment of the invention all three times t₁, t₂ and t₃ lie within the same wash or rinse cycle.

It can likewise be preferred if no more than two of the three times t₁, t₂ and t₃ lie within the same wash or rinse cycle.

In a further embodiment of the invention t₁ lies temporally before t₂ and t₂ temporally before t₃.

It can also be advantageous if t₁ lies temporally before t₃ and t₃ lies temporally before t₂.

It can further be preferred if t₁=t₂ and both lie temporally before t₃.

Particularly preferred embodiments of the method according to the invention have the characteristic feature that one or more of preparations A, B and/or C are added not just once but twice or even more to one or more of the washing liquors during the course of the cleaning method.

In a particularly preferred embodiment of the invention, the method is executed so that at least one of preparations A, B and C is added to a washing liquor at least one further time during the method.

The method according to the invention preferably includes a main wash cycle and a prewash and/or rinse cycle.

It is most particularly preferable for all three preparations A, B and C to be added during the course of the main wash cycle.

In a further preferred embodiment of the invention preparation A and/or B is added in both the main wash cycle and the prewash cycle, particularly if the prewash cycle is performed with hot water (i.e., water at over 30° C. and in particular over 40° C.).

In a further, particularly preferred embodiment of the invention preparation A and/or B is added in both the main wash cycle and the rinse cycle.

In likewise particularly preferred embodiments of the invention one or more of preparations A, B and/or C is added in portions in various wash or rinse cycles.

Thus a preferred embodiment of the method according to the invention has the characteristic feature that it includes a prewash cycle, and at least one partial quantity m_{AV}, m_{BV} and/or m_{CV} of the total quantities m_{A}, m_{B} and m_{C} of preparations A, B and C added during the overall method is added in the prewash cycle, each partial quantity preferably making up less than 50%, in particular less than 35%, of the total quantity.

A further preferred embodiment of the method according to the invention has the characteristic feature that it includes a rinse cycle, and at least one partial quantity m_{AK}, m_{BK} and/or m_{CK} of the total quantities m_{A}, m_{B} and m_{C} of preparations A, B and C added during the overall method is added in the rinse cycle, each partial quantity preferably making up less than 50%, in particular less than 35%, of the total quantity.

If the method according to the invention includes a rinse cycle, it is particularly preferable for a preparation A, B or C which includes a surfactant, in particular a non-ionic surfactant, to be added to the washing liquor during the rinse cycle.

An embodiment of the method in which a surfactant-containing preparation A, B or C is added to the washing liquor in both the main wash cycle and the rinse cycle is most particularly preferred.

Preparation A has a pH of advantageously about 6 to about 9 and preferably about 7 to about 8.

The washing liquor to which preparation A is added has a pH after addition of about 6.0 to about 11, preferably about 7.0 to about 10.5, and in particular about 7.5 to about 10.0.

Preparation B has a pH of advantageously about 9 to about 14 and preferably about 9.5 to about 13.

The washing liquor to which preparation B is added has a pH after addition of about 9.0 to about 14, preferably about 9.5 to about 13 and in particular about 10 to about 12.

It can further be preferred for the pH values of preparations A and B to differ by at least two units.

The washing liquor to which preparation C is added has a pH after addition of about 7.5 to about 12 and preferably about 8.5 to about 11.

In particularly preferred embodiments of the method according to the invention preparation B and in particular preparations A and B is/are liquid. Liquid refers to the state of aggregation of the preparations at 20° C. The term “liquids” within the meaning of the present invention also includes free-flowing dispersions.

In a further, particularly preferred embodiment of the method according to the invention preparation C is liquid. It is also possible, however, for preparation C to be solid and to constitute a powder, preferably a free-flowing or pourable powder, for example.

Preparations A, B and C, provided they are liquid, generally have a viscosity (Brookfield LVT-II viscometer at 20 rpm and 20° C., spindle 3) of about 5 to 5000 mPas, preferably about 20 to about 2000 mPas, particularly preferably 50 to 1000 mPas and in particular about 100 to about 500 mPas.

In a preferred embodiment of the invention, preparations A, B and C, provided they are liquid, have a viscosity (Brookfield LVT-II viscometer at 20 rpm and 20° C., spindle 3) of about 5 to about 5000 mPas, preferably about 20 to about 2000 mPas and particularly preferably about 100 to about 1000 mPas, and the addition of the preparations to the washing liquor(s) takes place from at least one water-soluble container. This can be a water-soluble multi-chamber container, and the addition of the preparations to the washing liquor(s) takes place in each case from separate chambers of this container.

In a further preferred embodiment of the invention, preparations A, B and C, provided they are liquid, have a viscosity (Brookfield LVT-II viscometer at 20 rpm and 20° C., spindle 3) of about 50 to about 5000 mPas, preferably about 75 to about 2000 mPas and particularly preferably about 100 to about 500 mPas, and the addition of the preparations to the washing liquor(s) takes place from at least one, in particular a common, water-insoluble container. The at least one water-insoluble container is in particular a dosing chamber of a dishwashing machine.

In a most particularly preferred embodiment of the invention, preparations A, B and C, provided they are liquid, have a viscosity (Brookfield LVT-II viscometer at 20 rpm and 20° C., spindle 3) of about 5 to about 1000 mPas, preferably about 20 to about 500 mPas and particularly preferably about 50 to about 200 mPas, and the addition of the preparations to the washing liquor(s) takes place in each case from mutually separate water-insoluble containers.

It can be particularly advantageous here if the mutually separate water-insoluble containers are components of a movable dispensing and dosing system, or of a dispensing and dosing system permanently connected to the dishwashing machine. Movable within the meaning of this application means that the dispensing and dosing system is not inseparably connected to a dishwashing machine but for example can be removed from a dishwashing machine or positioned in a dishwashing machine.

In this embodiment it is particularly preferable for the containers of the dispensing and dosing system to contain such large quantities of preparations A, B and C that the dishwashing method can be performed several times in succession without having to refill the containers.

A further preferred embodiment of the method according to the invention therefore has the characteristic feature that it is a washing method in a discontinuously operating dishwashing machine and the water-insoluble containers each contain a multiple, preferably a 10 to 50-fold and in particular a 20 to 40-fold, of the quantities of preparations A, B and C that are necessary to wash one load of dishes under conventional operating conditions.

Within the context of the present invention, agents have been found with which the methods described above can be performed in an advantageous manner.

Therefore the invention likewise provides a combination product comprising a packaging means and three preparations A, B and C contained separately from one another in this packaging means, comprising
A: about 0.01 to about 20, preferably about 0.05 to about 15 and in particular about 0.1 to about 10 wt. % of at least one protease and optionally
   a) at least one further enzyme, in particular at least one amylase, and/or
   b) at least one enzyme stabilizer and/or
   c) at least one polymer and/or
   d) at least one bleach activator and/or
   e) at least one bleach catalyst
B: about 3 to about 70, preferably about 5 to about 40 and in particular about 10 to about 30 wt. % of at least one alkalizing agent and optionally
   a) at least one complexing agent and/or
   b) at least one polymer
C: about 1 to about 95, preferably about 5 to about 80 and in particular about 20 to about 50 wt. % of at least one bleaching agent and optionally
   a) at least one non-aqueous solvent and/or
   b) at least one bleach activator and/or
   c) at least one bleach catalyst,
      preparations A, B and C differing from one another in their compositions, at least one of preparations A, B and C containing at least one surfactant and at least one of preparations A and B being liquid.

The further components optionally included in preparation A of the combination product, such as enzymes, in particular amylases, enzyme stabilizers, polymers, bleach activators and bleach catalysts, are described in more detail below.

A preferred combination product has the characteristic feature that preparation A contains at least one surfactant.

In preferred embodiments of the invention preparation A of the combination product contains at least one further enzyme, in particular at least one amylase, and/or at least one enzyme stabilizer.

Preparation A of the Combination Product Preferably Contains No Bleaching Agent.

The further components optionally included in preparation B of the combination product, such as complexing agents and polymers, are described in more detail below.

The further components optionally included in preparation C of the combination product, such as non-aqueous solvents, bleach activators and bleach catalysts, are likewise described in more detail below.

In a preferred embodiment of the invention preparation B of the combination product additionally contains at least one complexing agent, for example, in a quantity of about 0.1 to about 70, preferably about 5 to about 45 and in particular about 10 to about 20 wt. %.

In a further preferred embodiment of the invention preparation B of the combination product additionally contains water in a quantity of, for example, about 0.1 to about 80, preferably about 10 to about 75, particularly preferably about 25 to about 70 and in particular about 40 to about 60 wt. %.

All substances contained in preparation C of the combination product in addition to the at least one bleaching agent should be selected such that they are adequately stable in respect of said bleaching agent and that no undesired interactions occur. Thus substances which are susceptible to oxidation, such as ethanol or n-propanol, are self-evidently not preferred as constituent(s) of the preparation.

Preparation C of the combination product can moreover contain water, preferably in a quantity of less than about 10, in particular less than about 5 wt. %. In a further preferred embodiment of the invention preparation C is substantially free from water.

Preparation C of the combination product preferably contains no enzyme.

Preparation A of the combination product has a pH of about 6 to about 9 and preferably about 7 to about 8.

Preparation B of the combination product has a pH of about 9 to about 14 and preferably about 9.5 to about 13.

It can further be preferred for the pH values of preparations A and B of the combination product to differ by at least two units.

In particularly preferred embodiments of the combination products according to the invention preparation B and in particular preparations A and B is/are liquid. Liquid refers to the state of aggregation of the preparations at 20° C. The term “liquids” within the meaning of the present invention also includes free-flowing dispersions.

In a further, particularly preferred embodiment of a combination product according to the invention preparation C is liquid. It is also possible, however, for preparation C to be solid and to constitute a powder, preferably a free-flowing or pourable powder, for example.

Preparations A, B and C of the combination product, provided they are liquid, generally have a viscosity (Brookfield LVT-II viscometer at 20 rpm and 20° C., spindle 3) of about 5 to about 5000 mPas, preferably about 20 to about 2000 mPas, particularly preferably about 50 to about 1000 mPas and in particular about 100 to about 500 mPas.

In a preferred embodiment of the invention, preparations A, B and C of the combination product, provided they are liquid, have a viscosity (Brookfield LVT-II viscometer at 20 rpm and 20° C., spindle 3) of about 5 to about 5000 mPas, preferably about 20 to about 2000 mPas and particularly preferably about 100 to about 1000 mPas, and the packaging means comprises a water-soluble container, in particular a water-soluble multi-chamber container.

The water-soluble container is in particular a portion pack for the single dosing of a dishwashing agent into a dishwashing machine. Such portion packs are widely described in the prior art. They can take the form of pouches or injection-molded containers, for example, and particularly preferably the form of thermoformed containers. Injection-molded or thermoformed containers made from a water-soluble material such as polyvinyl alcohol are particularly preferred which contain preparations A, B and C in mutually separate chambers.

In a further preferred embodiment of the invention, preparations A, B and C of the combination product, provided they are liquid, have a viscosity (Brookfield LVT-II viscometer at rpm and 20° C., spindle 3) of about 50 to about 5000 mPas, preferably about 75 to about 2000 mPas and particularly preferably about 100 to about 500 mPas, and the packaging means comprises at least one water-insoluble container.

The packaging means is in particular a multi-chamber bottle, with each chamber preferably being provided with a spout.

In a most particularly preferred embodiment of the invention, preparations A, B and C of the combination product, provided they are liquid, have a viscosity (Brookfield LVT-II viscometer at 20 rpm and 20° C., spindle 3) of about 5 to about 1000 mPas, preferably about 20 to about 500 mPas and particularly preferably about 50 to about 200 mPas, and the packaging means comprises mutually separate water-insoluble containers for each of the preparations.

In a particularly advantageous embodiment the mutually separate water-insoluble containers are constituents of a movable dispensing and dosing system.

The invention therefore likewise provides a dispensing and dosing system comprising a combination product as described above.

Within the meaning of the present invention dispensing and dosing systems such as were described by the applicant in its German patent application having the same priority entitled “Dosiersystem zur Abgabe von flieβ-oder streufähigen Zubereitungen” (“Dosing system for supplying liquid or solid preparations”) are particularly suitable.

A dispensing and dosing system which is movable in the sense described above and which in particular is provided with its own power source, preferably a source for electrical power, is particularly preferred.

The ingredients of the preparations used in the methods according to the invention and contained in the combination products according to the invention are described in more detail below.

Of the proteases, those of the subtilisin type are preferred. Examples thereof are the subtilisins BPN' and Carlsberg and the developed forms thereof, the protease PB92, the subtilisins 147 and 309, the alkaline protease from Bacillus lentus, subtilisin DY, and the enzymes thermitase, proteinase K and the proteases TW3 and TW7, which can be assigned to the subtilases but no longer in the narrower sense to the subtilisins.

Other enzymes which can advantageously be used include amylases, lipases, hemicellulases, cellulases, perhydrolases or oxidoreductases, and preferably mixtures thereof. These enzymes are of natural origin in principle; starting from the natural molecules, improved variants are available for use in washing or cleaning agents which accordingly are preferably used. Washing or cleaning agents preferably contain enzymes in total quantities of 1×10⁻⁶ to 5 wt. %, relative to active protein. Protein concentration can be determined with the aid of known methods, for example the BCA method or the Biuret method.

Examples of amylases which can be used according to the invention are the α-amylases from Bacillus licheniformis, from B. amyloliquefaciens, from B. stearothermophilus, from Aspergillus niger and A. oryzae, and the further developments of the aforementioned amylases improved for use in washing and cleaning agents. Furthermore, the α-amylase from Bacillus sp. A 7-7 (DSM 12368) and the cyclodextrin glucanotransferase (CGTase) from B. agaradherens (DSM 9948) can be mentioned for this purpose.

Proteases and amylases are generally used not in the form of the pure protein but rather in the form of stabilized preparations which are capable of being stored and transported. Examples of these ready-to-use preparations include the solid preparations obtained by granulation, extrusion or lyophilization or, particularly in the case of agents in liquid or gel form, solutions of the enzymes, advantageously as concentrated as possible, with a low water content and/or mixed with stabilizers or other auxiliary agents.

It is also possible to combine two or more enzymes so that a single granulated product has multiple enzyme activities.

As can be seen from the preceding embodiments, the enzyme protein forms only a fraction of the total weight of conventional enzyme preparations. Protease and optionally amylase preparations preferably used according to the invention contain from about 0.1 to about 40 wt. %, preferably from about 0.2 to about 30 wt. %, particularly preferably between 0.4 to about 20 wt. % and in particular from about 0.8 to about 10 wt. % of the enzyme protein.

Also suitable for use according to the invention are lipases or cutinases, in particular because of their triglyceride-cleaving activities but also in order to produce peracids in situ from suitable precursors. These include for example the lipases obtainable originally from Humicola lanuginosa (Thermomyces lanuginosus) or the further developments thereof, in particular those with the amino acid exchange D96L. Furthermore, the cutinases which were originally isolated from Fusarium solani pisi and Humicola insolens can also be used, for example. Lipases or cutinases whose starting enzymes were originally isolated from Pseudomonas mendocina and Fusarium solanii can also be used.

Enzymes which are grouped together under the term hemicellulases can moreover be used. They include for example mannanases, xanthan lyases, pectin lyases (=pectinases), pectinesterases, pectate lyases, xyloglucanases (=xylanases), pullulanases and β-glucanases.

To increase the bleaching action, oxidoreductases, for example oxidases, oxygenases, catalases, peroxidases, such as halo-, chloro-, bromo-, lignin, glucose or manganese peroxidases, dioxygenases or laccases (phenoloxidases, polyphenoloxidases) can be used according to the invention. Preferably organic, particularly preferably aromatic compounds which interact with the enzymes are advantageously additionally added to strengthen the activity of the oxidoreductases concerned (enhancers) or to ensure the flow of electrons in the case of very differing redox potentials between the oxidizing enzymes and the stains (mediators).

Multiple enzymes and/or enzyme preparations, preferably liquid protease preparations and optionally amylase preparations, are preferably used.

An enzyme included in a preparation according to the invention can be protected against damage, particularly during storage, such as for example inactivation, denaturation or decomposition due to physical influences, oxidation or proteolytic cleavage for instance. If the enzymes are obtained by microbial means, an inhibition of proteolysis is particularly preferred, particularly as the preparations contain proteases. Preferred preparations according to the invention contain stabilizers for this purpose.

One group of stabilizers comprises reversible protease inhibitors. Benzamidine hydrochloride, borax, boric acids, borinic acids, boronic acids or the salts or esters thereof are frequently used for this purpose, among them above all derivatives with aromatic groups, for example ortho-, meta- or para-substituted phenyl boronic acids, in particular 4-formylphenylboronic acid (4-FPBA), or the salts or esters of the cited compounds. Peptide aldehydes, i.e. oligopeptides having a reduced C-terminus, in particular those comprising 2 to 50 monomers, are also used for this purpose. The peptidic reversible protease inhibitors include inter alia ovomucoid and leupeptin. Specific, reversible peptide inhibitors for the protease subtilisin and fusion proteins comprising proteases and specific peptide inhibitors are also suitable for this purpose.

Further enzyme stabilizers are amino alcohols such as mono-, di-, triethanol- and -propanolamine and mixtures thereof, aliphatic carboxylic acids up to C₁₂, such as for example lactic acid, succinic acid, other dicarboxylic acids or salts of the cited acids. End-capped fatty acid amide alkoxylates are also suitable for this purpose. Certain organic acids used as builders, as disclosed in WO 97/18287, are additionally capable of stabilizing an enzyme contained therein.

Low aliphatic alcohols, but above all polyols, such as for example glycerol, ethylene glycol, propylene glycol or sorbitol, are further commonly used enzyme stabilizers. In addition, diglycerol phosphate protects against denaturation due to physical influences. Calcium and/or magnesium salts, such as for example calcium acetate or calcium formate, are likewise used.

Polyamide oligomers or polymeric compounds such as lignin, water-soluble vinyl copolymers or cellulose ethers, acrylic polymers and/or polyamides stabilize the enzyme preparation against physical influences or pH variations among other things. Polyamine-N-oxide-containing polymers act simultaneously as enzyme stabilizers and as color transfer inhibitors. Other polymeric stabilizers are linear C₈-C₁₈ polyoxyalkylenes. Alkyl polyglycosides can also stabilize the enzymatic components of the agent according to the invention and are preferably additionally capable of increasing its performance. Crosslinked N-containing compounds preferably fulfill a double function as soil-release agents and as enzyme stabilizers. Hydrophobic, non-ionic polymer stabilizes in particular any cellulase that may be included.

Reducing agents and antioxidants increase the stability of enzymes against oxidative decomposition; sulfur-containing reducing agents are commonly used for this purpose, for example. Other examples are sodium sulfite and reducing sugars.

Combinations of stabilizers, for example of polyols, boric acid and/or borax, the combination of boric acid or borate, reducing salts and succinic acid or other dicarboxylic acids, or the combination of boric acid or borate with polyols or polyamino compounds and with reducing salts, are particularly preferably used. The action of peptide-aldehyde stabilizers is favorably increased by the combination with boric acid and/or boric acid derivatives and polyols and still further increased by the additional action of divalent cations, such as calcium ions for example.

A further agent used to particular advantage for stabilizing the enzymatic preparations is potassium sulfate (K₂SO₄).

Other preferred enzyme stabilizers are non-ionic surfactants, in particular those of the general formula R¹—CH(OH)CH₂O-(AO)_{w}-(A′O)ₓ-(A″O)_{y}-(A′″O)_{z}—R², also referred to below as “hydroxy mixed ethers”, wherein
R¹ is a straight-chain or branched, saturated or mono- or polyunsaturated C₆₋₂₄ alkyl or alkenyl residue;
R² is a linear or branched hydrocarbon residue having 2 to 26 carbon atoms;
A, A′, A″ and A″ independently are a residue of —CH₂CH₂, —CH₂CH₂—CH₂, —CH₂—CH(CH₃), —CH₂—CH₂—CH₂—CH₂, —CH₂—CH(CH₃)—CH₂—, —CH₂—CH(CH₂—CH₃),
w, x, y and z are values from 0.5 to 120, wherein x, y and/or z can also be 0.
   These surfactants are described in more detail below.

The polymers which can be used according to the invention include in particular the active washing or cleaning polymers, for example the rinsing polymers and/or polymers having an action as a softening agent. Cationic, anionic and amphoteric polymers can generally also be used in addition to non-ionic polymers.

“Cationic polymers” within the meaning of the present invention are polymers which carry a positive charge in the polymer molecule. This can be achieved for example through the presence of (alkyl)ammonium groupings or other positively charged groups in the polymer chain. Particularly preferred cationic polymers derive from the groups of quaternized cellulose derivatives, polysiloxanes having quaternary groups, cationic guar derivatives, polymeric dimethyldiallyl ammonium salts and copolymers thereof with esters and amides of acrylic acid and methacrylic acid, copolymers of vinyl pyrrolidone with quaternized derivatives of dialkyl aminoacrylate and methacrylate, vinyl pyrrolidone-methoimidazolinium chloride copolymers, quaternized polyvinyl alcohols or the polymers specified under the INCI names Polyquaternium 2, Polyquaternium 17, Polyquaternium 18 and Polyquaternium 27.

“Amphoteric polymers” within the meaning of the present invention have negatively charged groups or monomer units in addition to a positively charged group in the polymer chain. These groups can be carboxylic acids, sulfonic acids or phosphonic acids, for example.

Preferred preparations and combination products according to the invention have the characteristic feature that they contain a polymer having monomer units of the formula R¹R²C═CR³R⁴, in which each residue R¹, R², R³, R⁴ is selected independently of the others from hydrogen, derivatized hydroxy group, C₁₋₃₀ linear or branched alkyl groups, aryl, aryl-substituted C₁₋₃₀ linear or branched alkyl groups, polyalkoxylated alkyl groups, heteroatomic organic groups having at least one positive charge without charged nitrogen, at least one quaternized N atom or at least one amino group having a positive charge in the partial range of the pH range from 2 to 11, or salts thereof, with the proviso that at least one residue R¹, R², R³, R⁴ is a heteroatomic organic group having at least one positive charge without charged nitrogen, at least one quaternized N-atom or at least one amino group having a positive charge.

Particularly preferred cationic or amphoteric polymers within the context of the present application contain as monomer unit a compound of the general formula

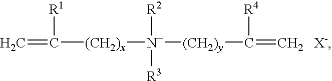

wherein R¹ and R⁴ independently are H or a linear or branched hydrocarbon residue having 1 to 6 carbon atoms; R² and R³ independently are an alkyl, hydroxyalkyl or aminoalkyl group in which the alkyl residue is linear or branched and has between 1 and 6 carbon atoms, preferably methyl; x and y independently are whole numbers from 1 to 3. X is a counterion, preferably chloride, bromide, iodide, sulfate, hydrogen sulfate, methosulfate, lauryl sulfate, dodecyl benzenesulfonate, p-toluenesulfonate (tosylate), cumenesulfonate, xylenesulfonate, phosphate, citrate, formate, acetate or mixtures thereof.

Preferred residues R¹ and R⁴ in the above formula are —CH₃, —CH₂—CH₃, —CH₂—CH₂—CH₃, —CH(CH₃)—CH₃, —CH₂—OH, —CH₂—CH₂—OH, —CH(OH)—CH₃, —CH₂—CH₂−CH₂—OH, —CH₂—CH(OH)—CH₃, —CH(OH)—CH₂—CH₃ or —(CH₂CH₂—O)ₙH.

Polymers having a cationic monomer unit of the above general formula in which R¹ and R⁴ denote H, R² and R³ denote methyl and x and y are each 1 are most particularly preferred. The corresponding monomer units of the formula

H₂C═CH—(CH₂)—N⁺(CH₃)₂—(CH₂)—CH═CH₂X⁻

are also known as DADMAC (diallyldimethyl ammonium chloride) if X⁻=chloride.

Further particularly preferred cationic or amphoteric polymers contain a monomer unit of the general formula

R¹HC═CR²—C(O)—NH—(CH₂)ₓ—N⁺R³R⁴R⁵) X⁻

wherein R¹, R², R³, R⁴ and R⁵ independently are a linear or branched, saturated or unsaturated alkyl or hydroxyalkyl residue having 1 to 6 carbon atoms, preferably a linear or branched alkyl residue chosen from —CH₃, —CH₂—CH₃, —CH₂—CH₂—CH₃, —CH(CH₃)—CH₃, —CH₂—OH, —CH₂—CH₂—OH, —CH(OH)—CH₃, —CH₂—CH₂—CH₂—OH, —CH₂—CH(OH)—CH₃, —CH(OH)—CH₂—CH₃ and —(CH₂CH₂—O)ₙH; and x is a whole number from 1 to 6.

Most particularly preferred within the context of the present application are polymers having a cationic monomer unit of the general formula above, wherein R¹ is H; R², R³, R⁴ and R⁵ are methyl; and x is 3. The corresponding monomer units of the formula

H₂C═C(CH₃)—C(O)—NH—(CH₂)ₓ—N⁺(CH₃)₃X⁻

are also known as MAPTAC (methacrylamidopropyl trimethyl ammonium chloride) if X⁻=chloride.

Polymers containing diallyldimethyl ammonium salts and/or acrylamidopropyl trimethyl ammonium salts as monomer units are preferably used according to the invention.

The aforementioned amphoteric polymers contain not only cationic groups but also anionic groups or monomer units. Such anionic monomer units derive for example from the group of linear or branched, saturated or unsaturated carboxylates, linear or branched, saturated or unsaturated phosphonates, linear or branched, saturated or unsaturated sulfates or linear or branched, saturated or unsaturated sulfonates. Preferred monomer units are acrylic acid, (meth)acrylic acid, (dimethyl) acrylic acid, (ethyl) acrylic acid, cyanoacrylic acid, vinyl acetic acid, allyl acetic acid, crotonic acid, maleic acid, fumaric acid, cinnamic acid and derivatives thereof, allyl sulfonic acids, such as for example allyloxybenzenesulfonic acid and methallyl sulfonic acid or allyl phosphonic acids.

Amphoteric polymers which can preferably be used derive from the group of alkylacrylamide/acrylic acid copolymers, alkylacrylamide/methacrylic acid copolymers, alkylacrylamide/methyl methacrylic acid copolymers, alkylacrylamide/acrylic acid/alkyl aminoalkyl(meth)acrylic acid copolymers, alkylacrylamide/methacrylic acid/alkylaminoalkyl(meth)acrylic acid copolymers, alkylacrylamide/methyl methacrylic acid/alkylaminoalkyl (meth)acrylic acid copolymers, alkylacrylamide/alkyl methacrylate/alkylaminomethyl methacrylate/alkyl methacrylate copolymers and the copolymers of unsaturated carboxylic acids, cationically derivatized unsaturated carboxylic acids and optionally further ionic or non-ionogenic monomers.

Zwitterionic polymers which can preferably be used derive from the group of acrylamidoalkyl trialkyl ammonium chloride/acrylic acid copolymers and the alkali and ammonium salts thereof, acrylamidoalkyl trialkyl ammonium chloride/methacrylic acid copolymers and the alkali and ammonium salts thereof and methacryloyl ethyl betaine/methacrylate copolymers.

Amphoteric polymers which in addition to one or more anionic monomers contain methacrylamidoalkyl trialkyl ammonium chloride and dimethyl (diallyl) ammonium chloride as cationic monomers are also preferred.

Particularly preferred amphoteric polymers derive from the group of methacrylamidoalkyl trialkyl ammonium chloride/dimethyl (diallyl) ammonium chloride/acrylic acid copolymers, methacrylamidoalkyl trialkyl ammonium chloride/dimethyl (diallyl) ammonium chloride/methacrylic acid copolymers and methacrylamidoalkyl trialkyl ammonium chloride/dimethyl (diallyl) ammonium chloride/alkyl (meth)acrylic acid copolymers and the alkali and ammonium salts thereof.

Amphoteric polymers from the group of methacrylamidopropyl trimethyl ammonium chloride/dimethyl (diallyl) ammonium chloride/acrylic acid copolymers, methacrylamidopropyl trimethyl ammonium chloride/dimethyl (diallyl) ammonium chloride/acrylic acid copolymers and methacrylamidopropyl trimethylammonium chloride/dimethyl (diallyl) ammonium chloride/alkyl (meth)acrylic acid copolymer and the alkali and ammonium salts thereof are preferred in particular.

In a particularly preferred embodiment of the present invention the polymers are in ready-to-use form. Suitable means for preparing the polymers include, inter alia
encapsulating the polymers by means of water-soluble or water-dispersible coating agents, preferably by means of water-soluble or water-dispersible natural or synthetic polymers;
encapsulating the polymers by means of water-insoluble, meltable coating agents, preferably by means of water-insoluble coating agents from the group of waxes or paraffins having a melting point above 30° C.;
cogranulation of the polymers with inert supporting materials, preferably with supporting materials from the group of active washing or cleaning substances, particularly preferably from the group of builders or cobuilders.

Polymers having an action as a softening agent are for example the polymers containing sulfonic acid groups, which are used to particular advantage.

Copolymers of unsaturated carboxylic acids, sulfonic-acid-group-containing monomers and optionally further ionogenic or non-ionogenic monomers can particularly preferably be used as sulfonic-acid-group-containing polymers. The sulfonic-acid-group-containing polymers can moreover also be hydrophobically modified.

Within the context of the present invention, unsaturated carboxylic acids of the formula

R¹(R²)C═C(R³)COOH

are preferred as monomers, wherein R¹ to R³ independently are —H, —CH₃, a straight-chain or branched saturated alkyl residue having 2 to 12 carbon atoms, a straight-chain or branched, mono- or polyunsaturated alkenyl residue having 2 to 12 carbon atoms, alkyl or alkenyl residues substituted with —NH₂, —OH or —COOH, or —COOH or —COOR⁴, where R⁴ is a saturated or unsaturated, straight-chain or branched hydrocarbon residue having 1 to 12 carbon atoms.

Of the unsaturated carboxylic acids which can be described by the formulae above, acrylic acid (R¹═R²R³═H), methacrylic acid (R¹═R²═H; R³═CH₃) and/or maleic acid (R¹═COOH; R²═R³═H) are particularly preferred.

Of the sulfonic-acid-group-containing monomers, those of the formula

R⁵(R⁶)C═C(R⁷)—X—SO₃H

are preferred, wherein R⁵ to R⁷ independently are —H, —CH₃, a straight-chain or branched saturated alkyl residue having 2 to 12 carbon atoms, a straight-chain or branched, mono- or polyunsaturated alkenyl residue having 2 to 12 carbon atoms, alkyl or alkenyl residues substituted with —NH₂, —OH or —COOH, or —COOH or —COOR⁴, where R⁴ is a saturated or unsaturated, straight-chain or branched hydrocarbon residue having 1 to 12 carbon atoms, and X is an optional spacer group chosen from —(CH₂)ₙ— where n=0 to 4, —COO—(CH₂)ₖ— where k=1 to 6, —C(O)—NH—C(CH₃)₂— and —C(O)—NH—CH(CH₂CH₃)—.

Of these monomers those of the formulae

H₂C═CH—X—SO₃H

H₂C═C(CH₃)—X—SO₃H

HO₃S—X—(R⁶)C═C(R⁷)—X—SO₃H

are preferred, wherein R⁶ and R⁷ are independently —H, —CH₃, —CH₂CH₃, —CH₂CH₂CH₃, or —CH(CH₃)₂ and X is an optional spacer group chosen from —(CH₂)ₙ— where n=0 to 4, —COO—(CH₂)ₖ— where k=1 to 6, —C(O)—NH—C(CH₃)₂— and —C(O)—NH—CH(CH₂CH₃)—.

Particularly preferred sulfonic-acid-group-containing monomers are 1-acrylamido-1-propanesulfonic acid, 2-acrylamido-2-propanesulfonic acid, 2-acrylamido-2-methyl-1-propanesulfonic acid, 2-methacrylamido-2-methyl-1-propanesulfonic acid, 3-methacrylamido-2-hydroxypropanesulfonic acid, allyl sulfonic acid, methallyl sulfonic acid, allyloxybenzenesulfonic acid, methallyloxybenzenesulfonic acid, 2-hydroxy-3-(2-propenyloxy)propanesulfonic acid, 2-methyl-2-propenel-sulfonic acid, styrenesulfonic acid, vinylsulfonic acid, 3-sulfopropyl acrylate, 3-sulfopropyl methacrylate, sulfomethacrylamide, sulfomethyl methacrylamide and water-soluble salts of the cited acids.

Ethylenically unsaturated compounds are also suitable in particular as further ionogenic or non-ionogenic monomers. The content of these further ionogenic or non-ionogenic monomers in the polymers used is preferably less than 20 wt. %, relative to the polymer. Polymers which are particularly preferably used consist solely of monomers of the formula R¹(R²)C═C(R³)COOH and monomers of the formula R⁵(R⁶)C═C(R⁷)—X—SO₃H.

In summary, copolymers of

i) unsaturated carboxylic acids of the formula

R¹(R²)C═C(R³)COOH
wherein R¹ to R³ independently are —H, —CH₃, a straight-chain or branched saturated alkyl residue having 2 to 12 carbon atoms, a straight-chain or branched, mono- or polyunsaturated alkenyl residue having 2 to 12 carbon atoms, alkyl or alkenyl residues substituted with —NH₂, —OH or —COOH as defined above, or —COOH or —COOR⁴, where R⁴ is a saturated or unsaturated, straight-chain or branched hydrocarbon residue having 1 to 12 carbon atoms,

ii) sulfonic-acid-group-containing monomers of the formula

R⁵(R⁶)C═C(R⁷)—X—SO₃H
wherein R⁵ to R⁷ independently are —H, —CH₃, a straight-chain or branched saturated alkyl residue having 2 to 12 carbon atoms, a straight-chain or branched, mono- or polyunsaturated alkenyl residue having 2 to 12 carbon atoms, alkyl or alkenyl residues substituted with —NH₂, —OH or —COOH as defined above, or —COOH or —COOR⁴, where R⁴ is a saturated or unsaturated, straight-chain or branched hydrocarbon residue having 1 to 12 carbon atoms, and X is an optional spacer group chosen from —(CH₂)ₙ— where n=0 to 4, —COO—(CH₂)ₖ— where k=1 to 6, —C(O)—NH—C(CH₃)₂— and —C(O)—NH—CH(CH₂CH₃)—,

iii) optionally further ionogenic or non-ionogenic monomers, are particularly preferred.

Further particularly preferred copolymers consist of

i) one or more unsaturated carboxylic acids from the group of acrylic acid, methacrylic acid and/or maleic acid

ii) one or more sulfonic-acid-group-containing monomers of the formulae:

H₂C═CH—X—SO₃H

H₂C═C(CH₃)—X—SO₃H

HO₃S—X—(R⁶)C═C(R⁷)—X—SO₃H
wherein R⁶ and R⁷ are independently —H, —CH₃, —CH₂CH₃, —CH₂CH₂CH₃, or —CH(CH₃)₂ and X is an optional spacer group chosen from —(CH₂)ₙ— where n=0 to 4, —COO—(CH₂)ₖ—where k=1 to 6, —C(O)—NH—C(CH₃)₂— and —C(O)—NH—CH(CH₂CH₃)—,

iii) optionally further ionogenic or non-ionogenic monomers.

Sulfonic acid groups can be present in the polymers in wholly or partially neutralized form (i.e., the acid hydrogen atom of the sulfonic acid group in some or all sulfonic acid groups can be exchanged for metal ions, preferably alkali metal ions, and in particular for sodium ions). The use of partially or completely neutralized sulfonic-acid-group-containing copolymers is preferred according to the invention.

The monomer distribution of the copolymers preferably used according to the invention, in the case of copolymers containing monomers from groups i) and ii) only, is preferably about 5 to about 95 wt. % of i) and ii) respectively, particularly preferably 50 to 90 wt. % of monomer from group i) and about 10 to about 50 wt. % of monomer from group ii), relative in each case to the polymer.

In the case of terpolymers, those containing about 20 to about 85 wt. % of monomer from group i), about 10 to about 60 wt. % of monomer from group ii) and about 5 to about 30 wt. % of monomer from group iii) are particularly preferred.

In a first preferred embodiment the copolymers also contain, in addition to at least one sulfonic-acid-group-containing monomer, at least one ionic monomer.

Unsaturated carboxylic acids are used as ionic monomers to particular advantage. Unsaturated carboxylic acids of the formula R¹(R²)C═C(R³)COOH are particularly preferred, wherein R¹ to R³ independently are —H, —CH₃, a straight-chain or branched saturated alkyl residue having 2 to 12 carbon atoms, a straight-chain or branched, mono- or polyunsaturated alkenyl residue having 2 to 12 carbon atoms, alkyl or alkenyl residues substituted with —NH₂, —OH or —COOH as defined above, or —COOH or —COOR⁴, where R⁴ is a saturated or unsaturated, straight-chain or branched hydrocarbon residue having 1 to 12 carbon atoms.

Particularly preferred carboxyl-group-containing monomers are acrylic acid, methacrylic acid, ethacrylic acid, α-chloroacrylic acid, α-cyanoacrylic acid, crotonic acid, α-phenyl acrylic acid, maleic acid, maleic anhydride, fumaric acid, itaconic acid, citraconic acid, methylene malonic acid, sorbic acid, cinnamic acid or mixtures thereof.

In a second preferred embodiment the copolymers also contain, in addition to at least one sulfonic-acid-group-containing monomer, at least one non-ionic, preferably hydrophobic, monomer.

Monomers of the general formula R¹(R²)C═C(R³)—X—R⁴ are preferably used as non-ionic monomers, wherein R¹ to R³ independently are —H, —CH₃ or —C₂H₅, X is an optional spacer group chosen from —CH₂—, —C(O)O— and —C(O)—NH—, and R⁴ is a straight-chain or branched, saturated alkyl residue having 2 to 22 carbon atoms or an unsaturated, preferably aromatic residue having 6 to 22 carbon atoms.

Particularly preferred non-ionic monomers are butene, isobutene, pentene, 3-methylbutene, 2-methylbutene, cyclopentene, hexene, hexene-1,2-methylpentene-1,3-methylpentene-1, cyclohexene, methylcyclopentene, cycloheptene, methylcyclohexene, 2,4,4-trimethylpentene-1,2,4,4-trimethylpentene-2,2,3-dimethylhexene-1,2,4-dimethylhexene-1,2,5-dimethylhexene-1,3,5-dimethylhexene-1,4,4-dimethylhexane-1, ethylcyclohexyne, 1-octene, α-olefins having 10 or more carbon atoms, such as for example 1-decene, 1-dodecene, 1-hexadecene, 1-octadecene and C22-α-olefin, 2-styrene, α-methylstyrene, 3-methylstyrene, 4-propylstyrene, 4-cyclohexylstyrene, 4-dodecylstyrene, 2-ethyl-4-benzylstyrene, 1-vinylnaphthalene, 2-vinylnaphthalene, methyl acrylate, ethyl acrylate, propyl acrylate, butyl acrylate, pentyl acrylate, hexyl acrylate, methyl methacrylate, N-(methyl)acrylamide, 2-ethylhexyl acrylate, 2-ethylhexyl methacrylate, N-(2-ethylhexyl)acrylamide, octyl acrylate, octyl methacrylate, N-(octyl)acrylamide, lauryl acrylate, lauryl methacrylate, N-(lauryl)acrylamide, stearyl acrylate, stearyl methacrylate, N-(stearyl)acrylamide, behenyl acrylate, behenyl methacrylate and N-(behenyl)acrylamide or mixtures thereof.

Molar mass of sulfo copolymers preferably used according to the invention can be varied in order to adjust the properties of the polymers to the desired application. Preferred preparations and combination products have copolymers having molar masses of about 2000 to about 200,000 gmol⁻¹, preferably about 4000 to about 25,000 gmol⁻¹ and in particular about 5000 to about 15,000 gmol⁻¹.

Bleaching agents suitable according to the invention include in addition to H₂O₂ the compounds sodium percarbonate, sodium perborate tetrahydrate and sodium perborate monohydrate which yield H₂O₂ in water. Further bleaching agents are for example peroxypyrophosphates, citrate perhydrates and H₂O₂-yielding peracidic salts or peracids, such as perbenzoate, peroxophthalate, diperazelaic acid, phthaloimino peracid or diperdodecanedioic acid. Typical organic bleaching agents are the diacyl peroxides, such as for example dibenzoyl peroxide. Further typical organic bleaching agents are the peroxy acids, with alkyl peroxy acids and aryl peroxy acids being cited in particular as examples. Preferred representatives are (a) peroxybenzoic acid and ring-substituted derivatives thereof, such as alkyl peroxybenzoic acids, but also peroxy-α-naphthoic acid and magnesium monoperphthalate, (b) aliphatic or substituted aliphatic peroxy acids, such as peroxylauric acid, peroxystearic acid, ε-phthalimidoperoxycaproic acid [phthaliminoperoxyhexanoic acid (PAP)], o-carboxybenzamidoperoxycaproic acid, N-nonenylamidoperadipic acid and N-nonenylamidopersuccinates, and (c) aliphatic and araliphatic peroxy dicarboxylic acids, such as 1,12-diperoxycarboxylic acid, 1,9-diperoxyazelaic acid, diperoxysebacic acid, diperoxybrassylic acid, diperoxyphthalic acids, 2-decyldiperoxybutane-1,4-dioic acid, N,N-terephthaloyl-di(6-aminopercaproic acid). Chlorine bleaching agents are not preferred according to the invention.

Temperature-resistant bleaching agents that remain stable even after repeatedly being heated to temperatures in the range of up to around 50 to 70° C. are preferred in particular according to the invention.

In a preferred embodiment of the present invention compositions such as are claimed in international patent application WO 2007/035009, in particular the compositions described in the embodiment examples therein, are used as preparations C containing bleaching agents.

In addition to bleaching agents, bleach activators and/or bleach catalysts are preferably used according to the invention in order to achieve an improved bleaching action when cleaning at temperatures of 60° C. and below. Compounds which under perhydrolysis conditions yield aliphatic peroxocarboxylic acids having preferably 1 to 10 C atoms, in particular 2 to 4 C atoms, and/or optionally substituted perbenzoic acid can be used as bleach activators. Substances carrying O and/or N acyl groups of the cited C atomic number and/or optionally substituted benzoyl groups are suitable. Polyacylated alkylene diamines, in particular tetraacetyl ethylene diamine (TAED), acylated triazine derivatives, in particular 1,5-diacetyl-2,4-dioxohexahydro-1,3,5-triazine (DADHT), acylated glycolurils, in particular tetraacetyl glycoluril (TAGU), N-acylimides, in particular N-nonanoyl succinimide (NOSI), acylated phenol sulfonates, in particular n-nonanoyl- or isononanoyloxybenzenesulfonate (n- or iso-NOBS), carboxylic anhydrides, in particular phthalic anhydride, acylated polyhydric alcohols, in particular triacetin, ethylene glycol diacetate and 2,5-diacetoxy-2,5-dihydrofuran, are preferred.

Bleach catalysts can also be used in addition to or in place of the conventional bleach activators. These substances are bleach-enhancing transition metal salts or transition metal complexes such as for example Mn, Fe, Co, Ru or Mo salt complexes or carbonyl complexes. Mn, Fe, Co, Ru, Mo, Ti, V and Cu complexes with N-containing tripod ligands and Co, Fe, Cu and Ru amine or acetate complexes can also be used as bleach catalysts.

Hydroxides, preferably alkali hydroxides, carbonates, hydrogen carbonates or sesquicarbonates, preferably alkali carbonates or alkali hydrogen carbonates or alkali sesquicarbonates, are particularly suitable as alkalizing agents, with alkali hydroxides and alkali carbonates, in particular sodium hydroxide, potassium hydroxides, sodium carbonate, sodium hydrogen carbonate or sodium sesquicarbonate, being preferably used within the meaning of this invention.

Other preferred alkalizing agents are organic amines, for example, primary and secondary alkyl amines, alkylene amines and mixtures of these organic amines. The group of preferred primary alkyl amines includes monoethylamine, monopropylamine, monobutylamine, monopentylamine and cyclohexylamine. The group of preferred secondary alkyl amines includes in particular dimethylamine.

Particularly preferred as alkalizing agents from organic amines are alkanol amines, in particular primary, secondary and tertiary alkanol amines and mixtures thereof. Particularly preferred primary alkanol amines are monoethanolamine (2-aminoethanol, MEA), monoisopropanolamine, diethylethanolamine (2-(diethylamino)ethanol). Particularly preferred secondary alkanol amines are diethanolamine (2,2′-iminodiethanol, DEA, bis(2-hydroxyethyl)amine), N-methyl-diethanolamine, N-ethyl-diethanolamine, diisopropanolamine and morpholine. Particularly preferred tertiary alkanol amines are triethanolamine and triisopropanolamine.

Within the meaning of the present invention polycarboxylic acids, polycarboxylates, polyacetals, dextrins, phosphates and phosphonates are suitable in particular as complexing agents.

Suitable complexing agents include polycarboxylic acids which can be used in the form of the free acid and/or its sodium salts, polycarboxylic acids being understood to be those carboxylic acids carrying more than one acid function. These are for example citric acid, adipic acid, succinic acid, glutaric acid, malic acid, tartaric acid, maleic acid, fumaric acid sugar acids, aminocarboxylic acids, nitrilotriacetic acid (NTA), provided that such a use is not to be opposed on ecological grounds, and mixtures thereof. Citric acid, succinic acid, glutaric acid, adipic acid, gluconic acid and any mixtures thereof are to be cited here in particular. Citric acid or salts of citric acid are used to particular advantage as complexing agents. A further particularly preferred complexing agent is methyl glycine diacetic acid (MGDA).

Also suitable as complexing agents are polymeric polycarboxylates, such as for example the alkali metal salts of polyacrylic acid or polymethacrylic acid, for example, those having a relative molar mass of 500 to 70,000 g/mol.

Within the meaning of this application the molar masses specified for the polymeric polycarboxylates are weight-average molar masses M_{w} of the individual acid form, which were determined in principle by gel permeation chromatography (GPC) using a UV detector. The measurement was carried out against an external polyacrylic acid standard, which because of its structural affinity to the polymers under investigation delivers realistic molar mass values. These figures differ markedly from the molar mass values obtained using polystyrene sulfonic acids as standard. The molar masses measured against polystyrene sulfonic acids are generally significantly higher than the molar masses given in this application.

Suitable polymers are in particular polyacrylates, which preferably have a molar mass of about 2000 to about 20,000 g/mol. Of this group, owing to their superior solubility, preference can in turn be given to the short-chain polyacrylates having molar masses of about 2000 to about 10,000 g/mol and particularly preferably about 3000 to about 5000 g/mol.

Also suitable are copolymeric polycarboxylates, in particular those of acrylic acid with methacrylic acid and of acrylic acid or methacrylic acid with maleic acid. Copolymers of acrylic acid with maleic acid which contain about 50 to about 90 wt. % of acrylic acid and about 50 to about 10 wt. % of maleic acid have proved to be particularly suitable. Their relative molar mass, relative to free acids, is generally about 2000 to about 70,000 g/mol, preferably about 20,000 to about 50,000 g/mol and in particular about 30,000 to about 40,000 g/mol.

To improve their solubility the polymers can also contain allyl sulfonic acids, such as allyloxybenzenesulfonic acid and methallyl sulfonic acid, as monomers.

Biodegradable polymers consisting of more than two different monomer units are also particularly preferred, for example those containing as monomers salts of acrylic acid and maleic acid and vinyl alcohol or vinyl alcohol derivatives or those containing as monomers salts of acrylic acid and 2-alkyl allyl sulfonic acid and sugar derivatives.

Other preferred polymeric polycarboxylates are those preferably having acrolein and acrylic acid/acrylic acid salts or acrolein and vinyl acetate as monomers.

Also to be mentioned as further preferred complexing agents are polymeric amino dicarboxylic acids, the salts thereof or the precursor substances thereof. Polyaspartic acids or salts thereof are particularly preferred.

Further suitable complexing agents are polyacetals, which can be obtained by reacting dialdehydes with polyol carboxylic acids having 5 to 7 C atoms and at least 3 hydroxyl groups. Preferred polyacetals are obtained from dialdehydes such as glyoxal, glutaraldehyde, terephthalaldehyde and mixtures thereof and from polyol carboxylic acids such as gluconic acid and/or glucoheptonic acid.

Furthermore, all compounds which are capable of forming complexes with alkaline-earth ions can be used as complexing agents.

The use of the generally known phosphates as complexing agents is also possible, of course, provided that such a use is not to be avoided on ecological grounds. Of the many commercially available phosphates, the alkali phosphates, with particular preference for pentasodium or pentapotassium triphosphate (sodium or potassium tripolyphosphate), have the greatest significance in the washing and cleaning agents industry.

Alkali phosphates is the summary term for the alkali metal (in particular sodium and potassium) salts of the various phosphoric acids, among which it is possible to differentiate between metaphosphoric acids (HPO₃)ₙ and orthophosphoric acids H₃PO₄ and higher-molecular-weight representatives. The phosphates combine several advantages: they act as alkali carriers, prevent limescale deposits on machine parts or limescale encrustations in fabrics and in addition contribute to the cleaning performance.

Particularly important phosphates in industry are pentasodium triphosphate, Na₅P₃O₁₀ (sodium tripolyphosphate) and the corresponding potassium salt pentapotassium triphosphate, K₅P₃O₁₀ (potassium tripolyphosphate). Sodium potassium tripolyphosphates are also preferably used according to the invention.

Complexing phosphonates include a series of different compounds such as 1-hydroxyethane-1,1-diphosphonic acid (HEDP) or diethylene triamine penta(methylene phosphonic acid) (DTPMP). Hydroxyalkane and aminoalkane phosphonates in particular are preferred in this application. Of particular importance among the hydroxyalkane phosphonates is 1-hydroxyethane-1,1-diphosphonate (HEDP). It is preferably used as a sodium salt, wherein the disodium salt reacts neutral and the tetrasodium salt reacts alkaline (pH 9). Ethylene diamine tetramethylene phosphonate (EDTMP), diethylene triamine pentamethylene phosphonate (DTPMP) and the higher homologs thereof are suitable as aminoalkane phosphonates. They are preferably used in the form of the neutral-reacting sodium salts, for example as hexasodium salt of EDTMP or as heptasodium and octasodium salt of DTPMP. HEDP is preferably used as the phosphonate. The aminoalkane phosphonates additionally have a pronounced heavy-metal-binding capacity. It can accordingly be preferable to use aminoalkane phosphonates, in particular DTPMP, or mixtures of the cited phosphonates.

Some of the substances described in the preceding text as complexing agents are also varyingly given the generic terms “builders” or “cobuilders” in the literature. Regardless of such other classifications, however, they are referred to within the meaning of the present invention as complexing agents.

Complexing agents can be included in each of the preparations A, B and C according to the invention. It is preferable, however, for preparation B to contain at least one complexing agent.

Non-aqueous solvents which are suitable according to the invention derive for example from the groups of monoalcohols, diols, triols or polyols of ethers, esters and/or amides. Non-aqueous solvents which are water-soluble are particularly preferred, wherein “water-soluble” solvents within the meaning of the present application are solvents which at room temperature are completely miscible with water (i.e., with no miscibility gaps).

Non-aqueous solvents which can be used in the agents according to the invention preferably derive from the group of monohydric or polyhydric alcohols, alkanol amines or glycol ethers, provided that they are miscible with water in the specified concentration range. The solvents are preferably selected from ethanol, n- or i-propanol, butanols, glycol, propane- or butanediol, glycerol, diglycol, propyl or butyl diglycol, hexylene glycol, ethylene glycol methyl ether, ethylene glycol ethyl ether, ethylene glycol propyl ether, ethylene glycol mono-n-butyl ether, diethylene glycol methyl ether, diethylene glycol ethyl ether, propylene glycol methyl, ethyl or propyl ether, dipropylene glycol methyl or ethyl ether, methoxy, ethoxy or butoxy triglycol, 1-butoxyethoxy-2-propanol, 3-methyl-3-methoxybutanol, propylene glycol-t-butyl ether and mixtures of these solvents.

If the non-aqueous solvents are a constituent (constituents) of preparation C, it is important to ensure that they are chemically sufficiently stable in relation to the bleaching agent used.

The group of surfactants which can be used according to the invention includes the non-ionic, anionic, cationic and amphoteric surfactants, but in particular the non-ionic surfactants.

All non-ionic surfactants known to the person skilled in the art are suitable in principle as non-ionic surfactants. Alkyl glycosides of the general formula RO(G)ₓ for example are suitable as non-ionic surfactants, wherein R is a primary straight-chain or methyl-branched aliphatic residue, in particular one methyl-branched in the 2-position, having 8 to 22, preferably 12 to 18 C atoms, and G is a glycose unit having 5 or 6 C atoms, preferably glucose. The degree of oligomerization x, which indicates the distribution of monoglycosides and oligoglycosides, is any number from 1 to 10; x is preferably from 1.2 to 1.4.

Another class of non-ionic surfactants preferably used, which are used either as the only non-ionic surfactant or in combination with other non-ionic surfactants, are alkoxylated, preferably ethoxylated or ethoxylated and propoxylated, fatty acid alkyl esters, preferably having 1 to 4 carbon atoms in the alkyl chain.

Slightly foaming non-ionic surfactants are used as preferred surfactants. Washing or cleaning agents, in particular cleaning agents for automatic dishwashing, contain to particular advantage non-ionic surfactants from the group of alkoxylated alcohols. Alkoxylated, advantageously ethoxylated, in particular primary alcohols having preferably 8 to 18 C atoms and on average 1 to 12 mol of ethylene oxide (EO) per mol of alcohol are preferably used as non-ionic surfactants, in which the alcohol residue can be linear or preferably methyl-branched in the 2-position or can contain linear and methyl-branched residues in the mixture, such as are conventionally present in oxoalcohol residues. However, alcohol ethoxylates having linear residues obtained from alcohols of native origin having 12 to 18 C atoms, for example from coconut, palm, tallow or oleyl alcohol, and on average 2 to 8 EO per mol of alcohol are particularly preferred. The preferred ethoxylated alcohols include, for example, C₁₂₋₁₄ alcohols having 3 EO or 4 EO, C₉₋₁₁ alcohol having 7 EO, C₁₃₋₁₅ alcohols having 3 EO, 5 EO, 7 EO or 8 EO, C₁₂₋₁₈ alcohols having 3 EO, 5 EO or 7 EO and mixtures thereof, such as mixtures of C_{12-14 alcohol having} 3 EO and C₁₂₋₁₈ alcohol having 5 EO. The specified degrees of ethoxylation are statistical averages which for an individual product can correspond to a whole number or a fraction. Preferred alcohol ethoxylates have a narrow homolog distribution (narrow-range ethoxylates, NRE). In addition to these non-ionic surfactants, fatty alcohols having more than 12 EO can also be used. Examples thereof are tallow fatty alcohol having 14 EO, 25 EO, 30 EO or 40 EO.

Ethoxylated non-ionic surfactants obtained from C₆₋₂₀ monohydroxyalkanols or C₆₋₂₀ alkyl phenols or C₁₆₋₂₀ fatty alcohols and more than 12 mol, preferably more than 15 mol and in particular more than 20 mol of ethylene oxide per mol of alcohol, are therefore used to particular advantage. A particularly preferred non-ionic surfactant is obtained from a straight-chain fatty alcohol having 16 to 20 carbon atoms (C₁₆₋₂₀ alcohol), preferably a C₁₋₈ alcohol, and at least 12 mol, preferably at least 15 mol and in particular at least 20 mol of ethylene oxide. Of these the so-called narrow-range ethoxylates are particularly preferred.

Furthermore, surfactants containing one or more tallow fatty alcohols with 20 to 30 EO in combination with a silicone defoaming agent are used to particular advantage.

Non-ionic surfactants having a melting point above room temperature are particularly preferred. Non-ionic surfactant(s) having a melting point above 20° C., preferably above 25° C., particularly preferably from 25 to 60° C. and in particular from 26.6 to 43.3° C., is/are particularly preferred.

Suitable non-ionic surfactants having melting or softening points in the cited temperature range are for example slightly foaming non-ionic surfactants, which can be solid or highly viscous at room temperature. If non-ionic surfactants which are highly viscous at room temperature are used, it is preferable for them to have a viscosity above 20 Pa·s, preferably above 35 Pa·s and in particular above 40 Pa·s. Non-ionic surfactants which have a waxy consistency at room temperature are also preferred.

Surfactants from the group of alkoxylated alcohols, particularly preferably from the group of mixed alkoxylated alcohols and in particular from the group of EO-AO-EO non-ionic surfactants, are likewise used to particular advantage.

The non-ionic surfactant that is solid at room temperature preferably has propylene oxide units in the molecule. Such PO units preferably account for up to about 25 wt. %, particularly preferably up to about 20 wt. % and in particular up to about 15 wt. % of the total molar mass of the non-ionic surfactant. Particularly preferred non-ionic surfactants are ethoxylated monohydroxy alkanols or alkyl phenols, which additionally have polyoxyethylene-polyoxypropylene block copolymer units. The alcohol or alkyl phenol component of such non-ionic surfactant molecules preferably accounts for more than about 30 wt. %, particularly preferably more than about 50 wt. % and in particular more than about 70 wt. % of the total molar mass of such non-ionic surfactants. Preferred agents have the characteristic feature that they contain ethoxylated and propoxylated non-ionic surfactants in which the propylene oxide units in the molecule account for up to about 25 wt. %, preferably up to about 20 wt. % and in particular up to about 15 wt. % of the total molar mass of the non-ionic surfactant.

Surfactants that are preferably used derive from alkoxylated non-ionic surfactants, in particular ethoxylated primary alcohols, and mixtures of these surfactants with structurally more complex surfactants such as polyoxypropylene/polyoxyethylene/polyoxypropylene ((PO/EO/PO) surfactants). Such (PO/EO/PO) non-ionic surfactants moreover have very good foam control.

Further non-ionic surfactants particularly preferably used having melting points above room temperature contain 40 to 70% of a polyoxypropylene/polyoxyethylene/polyoxypropylene block polymer blend containing 75 wt. % of a reverse block copolymer of polyoxyethylene and polyoxypropylene comprising 17 mol of ethylene oxide and 44 mol of propylene oxide, and 25 wt. % of a block copolymer of polyoxyethylene and polyoxypropylene, initiated with trimethylol propane and containing 24 mol of ethylene oxide and 99 mol of propylene oxide per mol of trimethylol propane.

Slightly foaming non-ionic surfactants having alternating ethylene oxide and alkylene oxide units have proved to be particularly preferred non-ionic surfactants within the context of the present invention. Of these, surfactants having EO-AO-EO-AO blocks are in turn preferred, with in each case one to ten EO or AO groups being bound to one another before a block of the other group follows. Non-ionic surfactants of the general formula

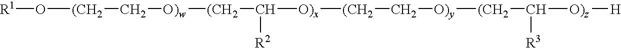

are preferred here, wherein R¹ is a straight-chain or branched, saturated or mono- or polyunsaturated C₆₋₂₄ alkyl or alkenyl residue; each R² or R³ is independently —CH₃, —CH₂CH₃, —CH₂CH₂—CH₃, or CH(CH₃)₂ and w, x, y, z independently are whole numbers from 1 to 6.

The preferred non-ionic surfactants of the above formula can be produced by known methods from the corresponding R¹—OH alcohols and ethylene or alkylene oxide. The residue R¹ in the above formula can vary according to the origin of the alcohol. If native sources are used, the residue R¹ has an even number of carbon atoms and is generally unbranched, with the linear residues of alcohols of native origin having 12 to 18 C atoms, for example from coconut, palm, tallow or oleyl alcohol, being preferred. Alcohols accessible from synthetic sources are for example the Guerbet alcohols or residues methyl-branched in the 2-position or a mixture of linear and methyl-branched residues, such as are conventionally present in oxoalcohol residues. Irrespective of the nature of the alcohol used to produce the non-ionic surfactants contained in the agents, non-ionic surfactants are preferred in which R¹ in the above formula denotes an alkyl residue having 6 to 24, preferably 8 to 20, particularly preferably 9 to 15 and in particular 9 to 11 carbon atoms.

In addition to propylene oxide, butylene oxide in particular is suitable as the alkylene oxide unit contained in alternating order with the ethylene oxide unit in the preferred non-ionic surfactants. However, further alkylene oxides, wherein R² and R³ are independently —CH₂CH₂—CH₃ or CH(CH₃)₂, are also suitable. Non-ionic surfactants of the above formula are preferably used wherein R² and R³ are a —CH₃ residue, w and x independently are values of 3 or 4 and y and z independently are values of 1 and 2.

In summary, non-ionic surfactants are preferred in particular which have a C₉₋₁₅ alkyl residue with 1 to 4 ethylene oxide units, followed by 1 to 4 propylene oxide units, followed by 1 to 4 ethylene oxide units, followed by 1 to 4 propylene oxide units. These surfactants have the necessary low viscosity in aqueous solution and can be used to particular advantage according to the invention.

Particularly preferred according to the invention are the non-ionic surfactants of the general formula R¹—CH(OH)CH₂O-(AO)_{w}-(A′O)-(A″O)_{y}-(A′″O)_{z}—R², also referred to below as “hydroxy mixed ethers”, wherein
R¹ denotes a straight-chain or branched, saturated or mono- or polyunsaturated C₆₋₂₄ alkyl or alkenyl residue;
R² denotes a linear or branched hydrocarbon residue having 2 to 26 carbon atoms;
A, A′, A″ and A′″ independently of one another denote a residue from the group —CH₂CH₂, —CH₂CH₂—C₂, —CH₂—CH(CH₃), —CH₂—CH₂—CH₂—CH₂, —CH₂—CH(CH₃)—CH₂—, —CH₂—CH(CH₂—CH₃),
w, x, y and z denote values between 0.5 and 120, wherein x, y and/or z can also be 0.

Such end-capped poly(oxyalkylated) non-ionic surfactants are preferred in particular which according to the formula R¹O[CH₂CH₂O]ₓCH₂CH(OH)R² also have, in addition to a residue R¹, which is linear or branched, saturated or unsaturated, aliphatic or aromatic hydrocarbon residues having 2 to 30 carbon atoms, preferably 4 to 22 carbon atoms, a linear or branched, saturated or unsaturated, aliphatic or aromatic hydrocarbon residue R² having 1 to 30 carbon atoms, where x is a value from 1 to 90, preferably from 30 to 80, and in particular from 30 to 60.

Surfactants of the formula R¹O[CH₂CH(CH₃)O]ₓ[CH₂CH₂O]_{y}CH₂CH(OH)R² are particularly preferred, wherein R¹ is a linear or branched aliphatic hydrocarbon residue having 4 to 18 carbon atoms or mixtures thereof, R² is a linear or branched hydrocarbon residue having 2 to 26 carbon atoms or mixtures thereof, x is a value from 0.5 to 1.5, and y is a value of at least 15.

These non-ionic surfactants include C₂₋₂₆ fatty alcohol-(PO)₁-(EO)₁₅₋₄₀-2-hydroxyalkyl ethers, in particular C₈₋₁₀ fatty alcohol-(PO)₁-(EO)₂₂-2-hydroxydecyl ethers.

Also particularly preferred are such end-capped poly(oxyalkylated) non-ionic surfactants of the formula R¹O[CH₂H₂O]ₓ[CH₂CH(R³)O]_{y}CH₂CH(OH)R² wherein R¹ and R² independently are a linear or branched, saturated or mono- or polyunsaturated hydrocarbon residue having 2 to 26 carbon atoms, R³ is —CH₃, —CH₂CH₃, —CH₂CH₂—CH₃, or —CH(CH₃)₂, but preferably is —CH₃, and x and y independently are values from 1 to 32, wherein non-ionic surfactants having R³═—CH₃ and values for x of 15 to 32 and y of from 0.5 to 1.5 are most particularly preferred.

Other non-ionic surfactants that can preferably be used are end-capped poly(oxyalkylated) non-ionic surfactants of the formula R¹O[CH₂CH(R³)O]ₓ[CH₂]ₖCH(OH)[CH₂]ⱼOR², wherein R¹ and R² are linear or branched, saturated or unsaturated, aliphatic or aromatic hydrocarbon residues having 1 to 30 carbon atoms, R³ is H or a methyl, ethyl, n-propyl, isopropyl, n-butyl, 2-butyl or 2-methyl-2-butyl residue, x is a value from 1 to 30, k and j are values from 1 to 12, preferably from 1 to 5. If the value x≧2, each R³ in the above formula R¹O[CH₂CH(R³)O]ₓ[CH₂]ₖCH(OH)[CH₂]ⱼOR² can be different. R¹ and R² are preferably linear or branched, saturated or unsaturated, aliphatic or aromatic hydrocarbon residues having 6 to 22 carbon atoms, with residues having 8 to 18 C atoms being particularly preferred. H, —CH₃ or —CH₂CH₃ are particularly preferred for the residue R³. Particularly preferred values for x are in the range from 1 to 20, preferably 6 to 15.

As is described above, each R³ in the above formula can be different if x 2. The alkylene oxide unit in the square brackets can be varied in this way. For example, if x denotes 3, the residue R³ can be selected in order to form ethylene oxide (R³═H) or propylene oxide (R³═CH₃) units, which can be combined in any sequence, for example (EO)(PO)(EO), (EO)(EO)(PO), (EO)(EO)(EO), (PO)(EO)(PO), (PO)(PO)(EO) and (PO)(PO)(PO). The value of 3 for x is chosen here by way of example and can certainly be greater, in which case the variation range increases as the value of x increases, and includes for example a large number of (EO) groups combined with a small number of (PO) groups or vice versa.

Particularly preferred end-capped poly(oxyalkylated) alcohols of the above formula have values of k=1 and j=1, so that the above formula can be simplified to R¹O[CH₂CH(R³)O]_{X}CH₂CH(OH)CH₂OR². In this last formula R¹, R² and R³ are as defined above and x is a value from 1 to 30, preferably from 1 to 20 and in particular from 6 to 18. Surfactants in which residues R¹ and R² have 9 to 14 C atoms, R³ denotes H and x assumes values from 6 to 15 are particularly preferred.

Finally, the non-ionic surfactants of the general formula R¹—CH(OH)CH₂O-(AO)_{w}—R² have proved to be particularly effective, in which
R¹ is a straight-chain or branched, saturated or mono- or polyunsaturated C₆₋₂₄ alkyl or alkenyl residue;
R² is a linear or branched hydrocarbon residue having 2 to 26 carbon atoms;
A is a residue from the group CH₂CH₂, —CH₂CH₂—CH₂, —CH₂—CH(CH₃), and
w is a value from 1 to 120, preferably from 10 to 80, in particular 20 to 40.

The group of these non-ionic surfactants includes for example the C₄₋₂₂ fatty alcohol-(EO)₁₀₋₈₀-2-hydroxyalkyl ethers, in particular also the C₈₋₁₂ fatty alcohol-(EO)₂₂-2-hydroxydecyl ethers and the C₄₋₂₂ fatty alcohol-(EO)₄₀₋₈₀-2-hydroxyalkyl ethers.

A further preferred surfactant is the surfactant of the general formula R¹O[CH₂CH(CH₃)O]ₓ[CH₂CH₂O]_{y}CH₂CH(OH)R², wherein R¹ is a linear or branched aliphatic hydrocarbon residue having 4 to 22 carbon atoms or mixtures thereof, R² is a linear or branched hydrocarbon residue having 2 to 26 carbon atoms or mixtures thereof, and x and y are a value from 1 to 40, the alkylene units [CH₂CH(CH₃)O] and [CH₂CH₂O] being randomized (i.e., being present in the form of a statistical, random distribution).

The specified C chain lengths and degrees of ethoxylation or degrees of alkoxylation of the aforementioned non-ionic surfactants are statistical averages which for an individual product can be a whole number or a fraction. By virtue of the method of preparation, commercial products of the cited formulae mostly consist not of a single representative but of mixtures, as a consequence of which averages and hence fractions can occur for both the C chain lengths and the degrees of ethoxylation or degrees of alkoxylation.

The aforementioned non-ionic surfactants can of course be used not only as individual substances but also as mixtures of surfactants comprising two, three, four or more surfactants. The term mixtures of surfactants refers here not to mixtures of non-ionic surfactants which in their entirety come under one of the aforementioned general formulae but rather mixtures containing two, three, four or more non-ionic surfactants which can be described by various of the aforementioned general formulae.

Cationic and/or amphoteric surfactants can also be used according to the invention.

Particularly advantageous formulations of combination products according to the invention are reproduced in Table 1 below.

TABLE 1

| Seq. | Preparation A, containing | Preparation B, containing | Preparation C, containing |
|---|---|---|---|
| no. | (numerical values = wt. %) | (numerical values = wt. %) | (numerical values = wt. %) |
| 1 | 10 to 75 builder(s); | 10 to 74.9 builder(s); | 0.1 to 75 bleaching agent |
| | 0.1 to 10 enzyme(s); | 25 to 89.9 water | |
| | 24.9 to 89.9 water; | | |
| 2 | 10 to 74.9 builder(s); | 10 to 74.9 builder(s); | 0.1 to 75 bleaching agent |
| | 0.1 to 10 enzyme(s); | 25 to 89.9 water | |
| | 24.9 to 89.8 water; | | |
| | 0.01 to 15 sulfonic-acid- | | |
| | group-containing polymer | | |
| 3 | 10 to 74.8 builder(s); | 10 to 74.9 builder(s); | 0.1 to 75 bleaching agent |
| | 0.1 to 10 enzyme(s); | 25 to 89.9 water | |
| | 24.9 to 89.7 water; | | |
| | 0.2 to 10.0 non-ionic | | |
| | surfactant | | |
| 4 | 10 to 74.7 builder(s); | 10 to 74.9 builder(s); | 0.1 to 75 bleaching agent |
| | 0.1 to 10 enzyme(s); | 25 to 89.9 water | |
| | 24.9 to 89.6 water; | | |
| | 0.2 to 10.0 non-ionic | | |
| | surfactant; | | |
| | 0.01 to 15 sulfonic-acid- | | |
| | group-containing polymer | | |
| 5 | 10 to 75 builder(s); | 10 to 74.8 builder(s); | 0.1 to 75 bleaching agent |
| | 0.1 to 10 enzyme(s); | 25 to 89.8 water; | |
| | 24.9 to 89.9 water; | 0.01 to 15 sulfonic-acid- | |
| | | group-containing polymer | |
| 6 | 10 to 74.9 builder(s); | 10 to 74.8 builder(s); | 0.1 to 75 bleaching agent |
| | 0.1 to 10 enzyme(s); | 25 to 89.8 water; | |
| | 24.9 to 89.8 water; | 0.01 to 15 sulfonic-acid- | |
| | 0.01 to 15 sulfonic-acid- | group-containing polymer | |
| | group-containing polymer | | |
| 7 | 10 to 74.8 builder(s); | 10 to 74.8 builder(s); | 0.1 to 75 bleaching agent |
| | 0.1 to 10 enzyme(s); | 25 to 89.8 water; | |
| | 24.9 to 89.7 water; | 0.01 to 15 sulfonic-acid- | |
| | 0.2 to 10.0 non-ionic | group-containing polymer | |
| | surfactant | | |
| 8 | 10 to 74.7 builder(s); | 10 to 74.8 builder(s); | 0.1 to 75 bleaching agent |
| | 0.1 to 10 enzyme(s); | 25 to 89.8 water; | |
| | 24.9 to 89.6 water; | 0.01 to 15 sulfonic-acid- | |
| | 0.2 to 10.0 non-ionic | group-containing polymer | |
| | surfactant; | | |
| | 0.01 to 15 sulfonic-acid- | | |
| | group-containing polymer | | |
| 9 | 10 to 75 builder(s); | 10 to 74.8 builder(s); | 0.1 to 75 bleaching agent |
| | 0.1 to 10 enzyme(s); | 25 to 89.8 water; | |
| | 24.9 to 89.9 water, | 0.01 to 8 cationic and/or | |
| | | amphoteric polymers | |
| 10 | 10 to 74.9 builder(s); | 10 to 74.8 builder(s); | 0.1 to 75 bleaching agent |
| | 0.1 to 10 enzyme(s); | 25 to 89.8 water; | |
| | 24.9 to 89.8 water; | 0.01 to 8 cationic and/or | |
| | 0.01 to 15 sulfonic-acid- | amphoteric polymers | |
| | group-containing polymer | | |
| 11 | 10 to 74.8 builder(s); | 10 to 74.8 builder(s); | 0.1 to 75 bleaching agent |
| | 0.1 to 10 enzyme(s); | 25 to 89.8 water; | |
| | 24.9 to 89.7 water; | 0.01 to 8 cationic and/or | |
| | 0.2 to 10.0 non-ionic | amphoteric polymers | |
| | surfactant | | |
| 12 | 10 to 74.7 builder(s); | 10 to 74.8 builder(s); | 0.1 to 75 bleaching agent |
| | 0.1 to 10 enzyme(s); | 25 to 89.8 water; | |
| | 24.9 to 89.6 water; | 0.01 to 8 cationic and/or | |
| | 0.2 to 10.0 non-ionic | amphoteric polymers | |
| | surfactant; | | |
| | 0.01 to 15 sulfonic-acid- | | |
| | group-containing polymer | | |
| 13 | 10 to 75 builder(s); | 10 to 74.7 builder(s); | 0.1 to 75 bleaching agent |
| | 0.1 to 10 enzyme(s); | 25 to 89.7 water; | |
| | 24.9 to 89.9 water; | 0.01 to 15 sulfonic-acid- | |
| | | group-containing polymer; | |
| | | 0.01 to 8 cationic and/or | |
| | | amphoteric polymers | |
| 14 | 10 to 74.9 builder(s); | 10 to 74.7 builder(s); | 0.1 to 75 bleaching agent |
| | 0.1 to 10 enzyme(s); | 25 to 89.7 water; | |
| | 24.9 to 89.8 water; | 0.01 to 15 sulfonic-acid- | |
| | 0.01 to 15 sulfonic-acid- | group-containing polymer; | |
| | group-containing polymer | 0.01 to 8 cationic and/or | |
| | | amphoteric polymers | |
| 15 | 10 to 74.8 builder(s); | 10 to 74.7 builder(s); | 0.1 to 75 bleaching agent |
| | 0.1 to 10 enzyme(s); | 25 to 89.7 water; | |
| | 24.9 to 89.7 water; | 0.01 to 15 sulfonic-acid- | |
| | 0.2 to 10.0 non-ionic | group-containing polymer; | |
| | surfactant | 0.01 to 8 cationic and/or | |
| | | amphoteric polymers | |
| 16 | 10 to 74.7 builder(s); | 10 to 74.7 builder(s); | 0.1 to 75 bleaching agent |
| | 0.1 to 10 enzyme(s); | 25 to 89.7 wt. % water | |
| | 24.9 to 89.6 water; | 0.01 to 15 sulfonic-acid- | |
| | 0.2 to 10.0 non-ionic | group-containing polymer; | |
| | surfactant; | 0.01 to 8 cationic and/or | |
| | 0.01 to 15 sulfonic-acid- | amphoteric polymers | |
| | group-containing polymer | | |

Combination products according to the invention are also suitable for automatic dosing. Particularly advantageous formulations for such preparations A, B and C for use in dispensing and dosing systems are reproduced in Table 2 below.

TABLE 2

| Seq. | Preparation A, containing | Preparation B, containing | Preparation C, containing |
|---|---|---|---|
| no. | (numerical values = wt. %) | (numerical values = wt. %) | (numerical values = wt. %) |
| 1 | 10 to 75 polyhydric | 10 to 74.9 builder(s); | 0.1 to 75 bleaching agent |
| | alcohol(s); | 10 to 89.9 water | |
| | 0.1 to 50 enzyme | | |
| | preparation(s); | | |
| | 1 to 25 surfactant | | |
| 2 | 10 to 75 polyhydric | 10 to 74.9 builder(s); | 0.1 to 75 bleaching agent |
| | alcohol(s); | 10 to 89.9 water | |
| | 0.1 to 50 enzyme | | |
| | preparation(s); | | |
| | 1 to 25 surfactant | | |
| | 0.01 to 5 lactic acid or | | |
| | lactic acid salts | | |
| 3 | 10 to 75 polyhydric | 10 to 74.9 builder(s); | 0.1 to 75 bleaching agent |
| | alcohol(s); | 10 to 89.9 water | |
| | 0.1 to 50 enzyme | | |
| | preparation(s) | | |
| | 1 to 25 surfactant | | |
| | 0.01 to 5 4-FPBA | | |
| 4 | 10 to 75 polyhydric | 10 to 74.9 builder(s); | 0.1 to 75 bleaching agent |
| | alcohol(s); | 10 to 89.9 water | |
| | 0.1 to 50 enzyme | | |
| | preparation(s); | | |
| | 1 to 25 surfactant | | |
| | 0.01 to 25 sugar alcohol(s) | | |
| 5 | 10 to 75 polyhydric | 10 to 74.9 builder(s); | 0.1 to 75 bleaching agent |
| | alcohol(s); | 10 to 89.9 water; | |
| | 0.1 to 50 enzyme | 0.01 to 15 sulfonic-acid- | |
| | preparation(s); | group-containing polymer | |
| | 1 to 25 surfactant | | |
| 6 | 10 to 75 polyhydric | 10 to 74.9 builder(s); | 0.1 to 75 bleaching agent |
| | alcohol(s); | 10 to 89.9 water; | |
| | 0.1 to 50 enzyme | 0.01 to 15 sulfonic-acid- | |
| | preparation(s); | group-containing polymer | |
| | 1 to 25 surfactant | | |
| | 0.01 to 5 lactic acid or | | |
| | lactic acid salts | | |
| 7 | 10 to 75 polyhydric | 10 to 74.9 builder(s); | 0.1 to 75 bleaching agent |
| | alcohol(s); | 10 to 89.9 water; | |
| | 0.1 to 50 enzyme | 0.01 to 15 sulfonic-acid- | |
| | preparation(s) | group-containing polymer | |
| | 1 to 25 surfactant | | |
| | 0.01 to 5 4-FPBA | | |
| 8 | 10 to 75 polyhydric | 10 to 74.9 builder(s); | 0.1 to 75 bleaching agent |
| | alcohol(s); | 10 to 89.9 water; | |
| | 0.1 to 50 enzyme | 0.01 to 15 sulfonic-acid- | |
| | preparation(s); | group-containing polymer | |
| | 1 to 25 surfactant | | |
| | 0.01 to 25 sugar alcohol(s) | | |
| 9 | 10 to 75 polyhydric | 10 to 74.9 builder(s); | 0.1 to 75 bleaching agent |
| | alcohol(s); | 10 to 89.9 water; | |
| | 0.1 to 50 enzyme | 0.01 to 15 hydrophobically | |
| | preparation(s); | modified sulfonic-acid- | |
| | 1 to 25 surfactant | group-containing polymer | |
| 10 | 10 to 75 polyhydric | 10 to 74.9 builder(s); | 0.1 to 75 bleaching agent |
| | alcohol(s); | 10 to 89.9 water; | |
| | 0.1 to 50 enzyme | 0.01 to 15 hydrophobically | |
| | preparation(s); | modified sulfonic-acid- | |
| | 1 to 25 surfactant | group-containing polymer | |
| | 0.01 to 5 lactic acid or | | |
| | lactic acid salts | | |
| 11 | 10 to 75 polyhydric | 10 to 74.9 builder(s); | 0.1 to 75 bleaching agent |
| | alcohol(s); | 10 to 89.9 water; | |
| | 0.1 to 50 enzyme | 0.01 to 15 hydrophobically | |
| | preparation(s) | modified sulfonic-acid- | |
| | 1 to 25 surfactant | group-containing polymer | |
| | 0.01 to 5 4-FPBA | | |
| 12 | 10 to 75 polyhydric | 10 to 74.9 builder(s); | 0.1 to 75 bleaching agent |
| | alcohol(s); | 10 to 89.9 water; | |
| | 0.1 to 50 enzyme | 0.01 to 15 hydrophobically | |
| | preparation(s); | modified sulfonic-acid- | |
| | 1 to 25 surfactant | group-containing polymer | |
| | 0.01 to 25 sugar alcohol(s) | | |
| 13 | 10 to 75 polyhydric | 10 to 74.9 builder(s); | 0.1 to 75 bleaching agent |
| | alcohol(s); | 10 to 89.9 water | |
| | 0.1 to 50 enzyme | 0.01 to 8 cationic or | |
| | preparation(s); | amphoteric polymer | |
| | 1 to 25 surfactant | | |
| 14 | 10 to 75 polyhydric | 10 to 74.9 builder(s); | 0.1 to 75 bleaching agent |
| | alcohol(s); | 10 to 89.9 water | |
| | 0.1 to 50 enzyme | 0.01 to 8 cationic or | |
| | preparation(s); | amphoteric polymer | |
| | 1 to 25 surfactant | | |
| | 0.01 to 5 lactic acid or | | |
| | lactic acid salts | | |
| 15 | 10 to 75 polyhydric | 10 to 74.9 builder(s); | 0.1 to 75 bleaching agent |
| | alcohol(s); | 10 to 89.9 water | |
| | 0.1 to 50 enzyme | 0.01 to 8 cationic or | |
| | preparation(s) | amphoteric polymer | |
| | 1 to 25 surfactant | | |
| | 0.01 to 5 4-FPBA | | |
| 16 | 10 to 75 polyhydric | 10 to 74.9 builder(s); | 0.1 to 75 bleaching agent |
| | alcohol(s); | 10 to 89.9 water | |
| | 0.1 to 50 enzyme | 0.01 to 8 cationic or | |
| | preparation(s); | amphoteric polymer | |
| | 1 to 25 surfactant | | |
| | 0.01 to 25 sugar alcohol(s) | | |
| 17 | 10 to 75 polyhydric | 10 to 74.9 builder(s); | 0.1 to 75 bleaching agent |
| | alcohol(s); | 10 to 89.9 water | |
| | 0.1 to 50 enzyme | | |
| | preparation(s); | | |
| | 1 to 25 surfactant | | |
| | 0.01 to 5 lactic acid or | | |
| | lactic acid salts | | |
| | 0.01 to 5 4-FPBA | | |
| 18 | 10 to 75 polyhydric | 10 to 74.9 builder(s); | 0.1 to 75 bleaching agent |
| | alcohol(s); | 10 to 89.9 water | |
| | 0.1 to 50 enzyme | | |
| | preparation(s); | | |
| | 1 to 25 surfactant | | |
| | 0.01 to 5 lactic acid or | | |
| | lactic acid salts | | |
| | 0.01 to 25 sugar alcohol(s) | | |
| 19 | 10 to 75 polyhydric | 10 to 74.9 builder(s); | 0.1 to 75 bleaching agent |
| | alcohol(s); | 10 to 89.9 water; | |
| | 0.1 to 50 enzyme | | |
| | preparation(s) | | |
| | 1 to 25 surfactant | | |
| | 0.01 to 5 4-FPBA | | |
| | 0.01 to 25 sugar alcohol(s) | | |
| 20 | 10 to 75 polyhydric | 10 to 74.9 builder(s); | 0.1 to 75 bleaching agent |
| | alcohol(s); | 10 to 89.9 water; | |
| | 0.1 to 50 enzyme | | |
| | preparation(s); | | |
| | 1 to 25 surfactant | | |
| | 0.01 to 5 lactic acid or | | |
| | lactic acid salts | | |
| | 0.01 to 5 4-FPBA | | |
| | 0.01 to 25 sugar alcohol(s) | | |
| 21 | 10 to 75 polyhydric | 10 to 74.9 builder(s); | 0.1 to 75 bleaching agent |
| | alcohol(s); | 10 to 89.9 water; | |
| | 0.1 to 50 enzyme | 0.01 to 15 sulfonic-acid- | |
| | preparation(s); | group-containing polymer | |
| | 1 to 25 surfactant | | |
| | 0.01 to 5 lactic acid or | | |
| | lactic acid salts | | |
| | 0.01 to 5 4-FPBA | | |
| 22 | 10 to 75 polyhydric | 10 to 74.9 builder(s); | 0.1 to 75 bleaching agent |
| | alcohol(s); | 10 to 89.9 water; | |
| | 0.1 to 50 enzyme | 0.01 to 15 sulfonic-acid- | |
| | preparation(s); | group-containing polymer | |
| | 1 to 25 surfactant | | |
| | 0.01 to 5 lactic acid or | | |
| | lactic acid salts | | |
| | 0.01 to 25 sugar alcohol(s) | | |
| 23 | 10 to 75 polyhydric | 10 to 74.9 builder(s); | 0.1 to 75 bleaching agent |
| | alcohol(s); | 10 to 89.9 water; | |
| | 0.1 to 50 enzyme | 0.01 to 15 sulfonic-acid- | |
| | preparation(s) | group-containing polymer | |
| | 1 to 25 surfactant | | |
| | 0.01 to 5 4-FPBA | | |
| | 0.01 to 25 sugar alcohol(s) | | |
| 24 | 10 to 75 polyhydric | 10 to 74.9 builder(s); | 0.1 to 75 bleaching agent |
| | alcohol(s); | 10 to 89.9 water; | |
| | 0.1 to 50 enzyme | 0.01 to 15 sulfonic-acid- | |
| | preparation(s); | group-containing polymer | |
| | 1 to 25 surfactant | | |
| | 0.01 to 5 lactic acid or | | |
| | lactic acid salts | | |
| | 0.01 to 5 4-FPBA | | |
| | 0.01 to 25 sugar alcohol(s) | | |
| 25 | 10 to 75 polyhydric | 10 to 74.9 builder(s); | 0.1 to 75 bleaching agent |
| | alcohol(s); | 10 to 89.9 water; | |
| | 0.1 to 50 enzyme | 0.01 to 15 hydrophobically | |
| | preparation(s); | modified sulfonic-acid- | |
| | 1 to 25 surfactant | group-containing polymer | |
| | 0.01 to 5 lactic acid or | | |
| | lactic acid salts | | |
| | 0.01 to 5 4-FPBA | | |
| 26 | 10 to 75 polyhydric | 10 to 74.9 builder(s); | 0.1 to 75 bleaching agent |
| | alcohol(s); | 10 to 89.9 water; | |
| | 0.1 to 50 enzyme | 0.01 to 15 hydrophobically | |
| | preparation(s); | modified sulfonic-acid- | |
| | 1 to 25 surfactant | group-containing polymer | |
| | 0.01 to 5 lactic acid or | | |
| | lactic acid salts | | |
| | 0.01 to 25 sugar alcohol(s) | | |
| 27 | 10 to 75 polyhydric | 10 to 74.9 builder(s); | 0.1 to 75 bleaching agent |
| | alcohol(s); | 10 to 89.9 water; | |
| | 0.1 to 50 enzyme | 0.01 to 15 hydrophobically | |
| | preparation(s) | modified sulfonic-acid- | |
| | 1 to 25 surfactant | group-containing polymer | |
| | 0.01 to 5 4-FPBA | | |
| | 0.01 to 25 sugar alcohol(s) | | |
| 28 | 10 to 75 polyhydric | 10 to 74.9 builder(s); | 0.1 to 75 bleaching agent |
| | alcohol(s); | 10 to 89.9 water; | |
| | 0.1 to 50 enzyme | 0.01 to 15 hydrophobically | |
| | preparation(s); | modified sulfonic-acid- | |
| | 1 to 25 surfactant | group-containing polymer | |
| | 0.01 to 5 lactic acid or | | |
| | lactic acid salts | | |
| | 0.01 to 5 4-FPBA | | |
| | 0.01 to 25 sugar alcohol(s) | | |
| 29 | 10 to 75 polyhydric | 10 to 74.9 builder(s); | 0.1 to 75 bleaching agent |
| | alcohol(s); | 10 to 89.9 water | |
| | 0.1 to 50 enzyme | 0.01 to 8 cationic or | |
| | preparation(s); | amphoteric polymer | |
| | 1 to 25 surfactant | | |
| | 0.01 to 5 lactic acid or | | |
| | lactic acid salts | | |
| | 0.01 to 5 4-FPBA | | |
| 30 | 10 to 75 polyhydric | 10 to 74.9 builder(s); | 0.1 to 75 bleaching agent |
| | alcohol(s); | 10 to 89.9 water | |
| | 0.1 to 50 enzyme | 0.01 to 8 cationic or | |
| | preparation(s); | amphoteric polymer | |
| | 1 to 25 surfactant | | |
| | 0.01 to 5 lactic acid or | | |
| | lactic acid salts | | |
| | 0.01 to 25 sugar alcohol(s) | | |
| 31 | 10 to 75 polyhydric | 10 to 74.9 builder(s); | 0.1 to 75 bleaching agent |
| | alcohol(s); | 10 to 89.9 water | |
| | 0.1 to 50 enzyme | 0.01 to 8 cationic or | |
| | preparation(s) | amphoteric polymer | |
| | 1 to 25 surfactant | | |
| | 0.01 to 5 4-FPBA | | |
| | 0.01 to 25 sugar alcohol(s) | | |
| 32 | 10 to 75 polyhydric | 10 to 74.9 builder(s); | 0.1 to 75 bleaching agent |
| | alcohol(s); | 10 to 89.9 water | |
| | 0.1 to 50 enzyme | 0.01 to 8 cationic or | |
| | preparation(s); | amphoteric polymer | |
| | 1 to 25 surfactant | | |
| | 0.01 to 5 lactic acid or | | |
| | lactic acid salts | | |
| | 0.01 to 5 4-FPBA | | |
| | 0.01 to 25 sugar alcohol(s) | | |
| 33 | 10 to 75 polyhydric | 10 to 74.9 builder(s); | |
| | alcohol(s); | 10 to 89.9 water; | |
| | 0.1 to 50 enzyme | 0.01 to 15 sulfonic-acid- | |
| | preparation(s); | group-containing polymer, | |
| | 1 to 25 surfactant | 0.01 to 15 hydrophobically | |
| | 0.01 to 5 lactic acid or | modified sulfonic-acid- | |
| | lactic acid salts | group-containing polymer | |
| | 0.01 to 5 4-FPBA | | |
| 34 | 10 to 75 polyhydric | 10 to 74.9 builder(s); | |
| | alcohol(s); | 10 to 89.9 water; | |
| | 0.1 to 50 enzyme | 0.01 to 15 sulfonic-acid- | |
| | preparation(s); | group-containing polymer, | |
| | 1 to 25 surfactant | 0.01 to 15 hydrophobically | |
| | 0.01 to 5 lactic acid or | modified sulfonic-acid- | |
| | lactic acid salts | group-containing polymer | |
| | 0.01 to 25 sugar alcohol(s) | | |
| 35 | 10 to 75 polyhydric | 10 to 74.9 builder(s); | |
| | alcohol(s); | 10 to 89.9 water; | |
| | 0.1 to 50 enzyme | 0.01 to 15 sulfonic-acid- | |
| | preparation(s) | group-containing polymer, | |
| | 1 to 25 surfactant | 0.01 to 15 hydrophobically | |
| | 0.01 to 5 4-FPBA | modified sulfonic-acid- | |
| | 0.01 to 25 sugar alcohol(s) | group-containing polymer | |
| 36 | 10 to 75 polyhydric | 10 to 74.9 builder(s); | 0.1 to 75 bleaching agent |
| | alcohol(s); | 10 to 89.9 water; | |
| | 0.1 to 50 enzyme | 0.01 to 15 sulfonic-acid- | |
| | preparation(s); | group-containing polymer, | |
| | 1 to 25 surfactant | 0.01 to 15 hydrophobically | |
| | 0.01 to 5 lactic acid or | modified sulfonic-acid- | |
| | lactic acid salts | group-containing polymer | |
| | 0.01 to 5 4-FPBA | | |
| | 0.01 to 25 sugar alcohol(s) | | |
| 37 | 10 to 75 polyhydric | 10 to 74.9 builder(s); | 0.1 to 75 bleaching agent |
| | alcohol(s); | 10 to 89.9 water, | |
| | 0.1 to 50 enzyme | 0.01 to 15 sulfonic-acid- | |
| | preparation(s); | group-containing polymer, | |
| | 1 to 25 surfactant | 0.01 to 8 cationic or | |
| | 0.01 to 5 lactic acid or | amphoteric polymer | |
| | lactic acid salts | | |
| | 0.01 to 5 4-FPBA | | |
| 38 | 10 to 75 polyhydric | 10 to 74.9 builder(s); | 0.1 to 75 bleaching agent |
| | alcohol(s); | 10 to 89.9 water, | |
| | 0.1 to 50 enzyme | 0.01 to 15 sulfonic-acid- | |
| | preparation(s); | group-containing polymer, | |
| | 1 to 25 surfactant | 0.01 to 8 cationic or | |
| | 0.01 to 5 lactic acid or | amphoteric polymer | |
| | lactic acid salts | | |
| | 0.01 to 25 sugar alcohol(s) | | |
| 39 | 10 to 75 polyhydric | 10 to 74.9 builder(s); | 0.1 to 75 bleaching agent |
| | alcohol(s); | 10 to 89.9 water, | |
| | 0.1 to 50 enzyme | 0.01 to 15 sulfonic-acid- | |
| | preparation(s) | group-containing polymer, | |
| | 1 to 25 surfactant | 0.01 to 8 cationic or | |
| | 0.01 to 5 4-FPBA | amphoteric polymer | |
| | 0.01 to 25 sugar alcohol(s) | | |
| 40 | 10 to 75 polyhydric | 10 to 74.9 builder(s); | 0.1 to 75 bleaching agent |
| | alcohol(s); | 10 to 89.9 water, | |
| | 0.1 to 50 enzyme | 0.01 to 15 sulfonic-acid- | |
| | preparation(s); | group-containing polymer, | |
| | 1 to 25 surfactant | 0.01 to 8 cationic or | |
| | 0.01 to 5 lactic acid or | amphoteric polymer | |
| | lactic acid salts | | |
| | 0.01 to 5 4-FPBA | | |
| | 0.01 to 25 sugar alcohol(s) | | |
| 41 | 10 to 75 polyhydric | 10 to 74.9 builder(s); | 0.1 to 75 bleaching agent |
| | alcohol(s); | 10 to 89.9 water, | |
| | 0.1 to 50 enzyme | 0.01 to 15 hydrophobically | |
| | preparation(s); | modified sulfonic-acid- | |
| | 1 to 25 surfactant | group-containing polymer, | |
| | 0.01 to 5 lactic acid or | 0.01 to 8 cationic or | |
| | lactic acid salts | amphoteric polymer | |
| | 0.01 to 5 4-FPBA | | |
| 42 | 10 to 75 polyhydric | 10 to 74.9 builder(s); | 0.1 to 75 bleaching agent |
| | alcohol(s); | 10 to 89.9 water, | |
| | 0.1 to 50 enzyme | 0.01 to 15 hydrophobically | |
| | preparation(s); | modified sulfonic-acid- | |
| | 1 to 25 surfactant | group-containing polymer, | |
| | 0.01 to 5 lactic acid or | 0.01 to 8 cationic or | |
| | lactic acid salts | amphoteric polymer | |
| | 0.01 to 25 sugar alcohol(s) | | |
| 43 | 10 to 75 polyhydric | 10 to 74.9 builder(s); | 0.1 to 75 bleaching agent |
| | alcohol(s); | 10 to 89.9 water, | |
| | 0.1 to 50 enzyme | 0.01 to 15 hydrophobically | |
| | preparation(s) | modified sulfonic-acid- | |
| | 1 to 25 surfactant | group-containing polymer, | |
| | 0.01 to 5 4-FPBA | 0.01 to 8 cationic or | |
| | 0.01 to 25 sugar alcohol(s) | amphoteric polymer | |
| 44 | 10 to 75 polyhydric | 10 to 74.9 builder(s); | 0.1 to 75 bleaching agent |
| | alcohol(s); | 10 to 89.9 water, | |
| | 0.1 to 50 enzyme | 0.01 to 15 hydrophobically | |
| | preparation(s); | modified sulfonic-acid- | |
| | 1 to 25 surfactant | group-containing polymer, | |
| | 0.01 to 5 lactic acid or | 0.01 to 8 cationic or | |
| | lactic acid salts | amphoteric polymer | |
| | 0.01 to 5 4-FPBA | | |
| | 0.01 to 25 sugar alcohol(s) | | |
| 45 | 10 to 75 polyhydric | 10 to 74.9 builder(s); | |
| | alcohol(s); | 10 to 89.9 water; | |
| | 0.1 to 50 enzyme | 0.01 to 15 sulfonic-acid- | |
| | preparation(s); | group-containing polymer, | |
| | 1 to 25 surfactant | 0.01 to 15 hydrophobically | |
| | 0.01 to 5 lactic acid or | modified sulfonic-acid- | |
| | lactic acid salts | group-containing polymer, | |
| | 0.01 to 685 4-FPBA | 0.01 to 8 cationic or | |
| | | amphoteric polymer | |
| 46 | 10 to 75 polyhydric | 10 to 74.9 builder(s); | |
| | alcohol(s); | 10 to 89.9 water; | |
| | 0.1 to 50 enzyme | 0.01 to 15 sulfonic-acid- | |
| | preparation(s); | group-containing polymer, | |
| | 1 to 25 surfactant | 0.01 to 15 hydrophobically | |
| | 0.01 to 5 lactic acid or | modified sulfonic-acid- | |
| | lactic acid salts | group-containing polymer, | |
| | 0.01 to 25 sugar alcohol(s) | 0.01 to 8 cationic or | |
| | | amphoteric polymer | |
| 47 | 10 to 75 polyhydric | 10 to 74.9 builder(s); | |
| | alcohol(s); | 10 to 89.9 water; | |
| | 0.1 to 50 enzyme | 0.01 to 15 sulfonic-acid- | |
| | preparation(s) | group-containing polymer, | |
| | 1 to 25 surfactant | 0.01 to 15 hydrophobically | |
| | 0.01 to 5 4-FPBA | modified sulfonic-acid- | |
| | 0.01 to 25 sugar alcohol(s) | group-containing polymer, | |
| | | 0.01 to 8 cationic or | |
| | | amphoteric polymer | |
| 48 | 10 to 75 polyhydric | 10 to 74.9 builder(s); | |
| | alcohol(s); | 10 to 89.9 water; | |
| | 0.1 to 50 enzyme | 0.01 to 15 sulfonic-acid- | |
| | preparation(s); | group-containing polymer, | |
| | 1 to 25 surfactant | 0.01 to 15 hydrophobically | |
| | 0.01 to 5 lactic acid or | modified sulfonic-acid- | |
| | lactic acid salts | group-containing polymer, | |
| | 0.01 to 5 4-FPBA | 0.01 to 8 cationic or | |
| | 0.01 to 25 sugar alcohol(s) | amphoteric polymer | |

The enzyme preparation contained in preparation A contains for example, in addition to the actual enzyme protein, water and/or non-aqueous solvents such as 1,2-propylene glycol and enzyme stabilizers. 4-FPBA stands for 4-formylphenylboronic acid, which is an enzyme stabilizer.

In addition to the cited ingredients, preparations A, B and C according to the invention can contain further conventional ingredients of dishwashing agents, such as for example silicates and other builders, surfactants, thickening agents, glass corrosion inhibitors, corrosion inhibitors, fragrances and perfume carriers, dyes and preserving agents.

In order to achieve the desired viscosity of the preparations according to the invention, it can be advantageous to add thickening agents to these agents, in particular thickening agents from the group of agar-agar, carrageen, tragacanth gum, gum arabic, alginates, pectins, polyoses, guar meal, carob seed meal, starch, dextrins, gelatin, casein, carboxymethyl cellulose, seed meal ethers, polyacrylic and polymethacrylic compounds, vinyl polymers, polycarboxylic acids, polyethers, polyimines, polyamides, polysilicas, clay minerals such as montmorillonites, zeolites and silicas.

Polymers of natural origin which can be used as thickening agents in the context of the present invention are as described above for example agar-agar, carrageen, tragacanth gum, gum arabic, alginates, pectins, polyoses, guar meal, carob seed meal, starch, dextrins, gelatin and casein. Modified natural substances derive above all from the group of modified starches and celluloses, with carboxymethyl cellulose and other cellulose ethers, hydroxyethyl and hydroxypropyl cellulose and seed meal ethers being mentioned by way of example.

Thickening agents that are widely used in a diverse range of application areas include fully synthetic polymers such as polyacrylic and polymethacrylic compounds, vinyl polymers, polycarboxylic acids, polyethers, polyimines, polyamides and polyurethanes. Thickening agents from these classes of substances are widely available commercially and are offered for example under the trade names Acusol®-820 (methacrylic acid (stearyl alcohol-20-EO) ester-acrylic acid copolymer, 30% in water, Rohm & Haas), Dapral®-GT-282-S (alkyl polyglycol ether, Akzo), Deuterol®-Polymer-11 (dicarboxylic acid copolymer, Schöner GmbH), Deuteron®-XG (anionic heteropolysaccharide based on β-D-glucose, D-mannose, D-glucuronic acid, Schöner GmbH), Deuteron®-XN (non-ionogenic polysaccharide, Schöner GmbH), Dicrylan® Thickener O (ethylene oxide adduct, 50% in water/isopropanol, Pfersse Chemie), EMA®-81 and EMA®-91 (ethylene-maleic anhydride copolymer, Monsanto), Thickener QR 1001 (polyurethane emulsion, 19-21% in water/diglycol ether, Rohm & Haas), Mirox®-AM (anionic acrylic acid-acrylic acid ester copolymer dispersion, 25% in water, Stockhausen), SER-AD-FX-1100 (hydrophobic urethane polymer, Servo Delden), Shellflo®-S (high-molecular-weight polysaccharide, stabilized with formaldehyde, Shell) and Shellflo®-XA (xanthan gum biopolymer, stabilized with formaldehyde, Shell).

### EMBODIMENT EXAMPLES

### Preparations Used

| | Preparation A | Preparation B |
|---|---|---|
| Ingredient | [wt. %] | [wt. %] |
| Potassium tripolyphosphate | 35 | 25 |
| (50% active substance) | | |
| KOH | 1 | 5 |
| HEDP | 3 | 3 |
| Anionic copolymer ¹⁾ | — | 8 |
| Non-ionic surfactant | 4 | — |
| Protease preparation ²⁾ | 2.0 | — |
| Amylase preparation | 0.8 | — |
| Alkanol amine | — | 3 |
| Water | 54.2 | 56 |

¹⁾ Anionic copolymer comprising
i) unsaturated carboxylic acid(s), and
ii) sulfonic-acid-group-containing monomer(s).
²⁾ Contains 4.5 wt. % protease relative to the protease preparation.

### Preparation C1:

40 wt. % percarbonate

40 wt. % non-aqueous organic solvent

10 wt. % non-ionic surfactant

5 wt. % TAED

1 wt. % Mn catalyst

further ingredients to make up to 100 wt. %

Preparation C1 is liquid at 20° C.

### Preparation C2:

50 wt. % PAP

10 wt. % stabilizer

30 wt. % non-aqueous solvent

1 wt. % thickener

further ingredients to make up to 100 wt. %

Preparation C2 is a liquid at 20° C.

### Preparation C3:

80 wt. % percarbonate

5 wt. % TAED

1 wt. % Mn catalyst

5 wt. % stabilizer

further ingredients to make up to 100 wt. %

Preparation C3 is a solid (powder) at 20° C.

In an automatic dishwashing method soiled dishes were washed in a dishwashing machine (Miele G 698) with a water hardness of 21° dH and at a temperature of 50° C. The preparations listed in the table below were added to the washing liquor in the specified quantities at the same time in the main wash cycle.

Tea and egg yolk removal achieved was assessed by the IKW method. The results are shown in the table below (the specified values are the averages from 3 tests):

| Preparations used | Tea removal | Egg yolk removal |
|---|---|---|
| 20 g A + 20 g B | 2.5 | 4.4 |
| 20 g A + 20 g B + 5 g C1 | 9.3 | 6.4 |
| 20 g A + 20 g B + 4 g C2 | 8.9 | 5.4 |
| 20 g A + 20 g B + 3 g C3 | 10.0 | 5.5 |

The test results show that through the use of the bleaching-agent-containing preparations C1 to C3 not only the cleaning performance on bleachable stains, in this case tea, increased massively but at the same time surprisingly the cleaning performance on protein-based stains not only was not reduced but actually increased.

We claim:

1. A method for machine-washing dishes comprising:
contacting the dishes in a wash or rinse cycle with at least one aqueous washing liquor, wherein there is at least one wash or rinse cycle,
wherein when there is more than one wash or rinse cycle, the at least one washing liquor is at least partially replaced between the wash or rinse cycle,
adding to the at least one washing liquor a preparation A at a time t₁, preparation A having at least one protease and optionally at least one further enzyme, at least one enzyme stabilizer, at least one polymer, at least one bleach activator, and/or at least one bleach catalyst,
adding to the at least one washing liquor a preparation B at a time t₂, preparation B having at least one alkalizing agent and optionally at least one complexing agent and/or at least one polymer, and
adding to the at least one washing liquor a preparation C at a time t₃, preparation C having at least one bleaching agent and optionally at least one non-aqueous solvent, at least one bleach activator, and/or at least one bleach catalyst,
wherein preparations A, B and C differ from one another in composition, at least one of preparations A, B and C contain at least one surfactant, at least one of preparations A and B is liquid, and at least one washing liquor contains for at least part of the time both protease and bleaching agent.

2. Method according to claim 1, wherein preparation A comprises at least one surfactant.

3. Method according to claim 1, wherein preparation A comprises at least one protease in an amount of about 0.01 to about 20 wt. %.

4. Method according to claim 1, wherein preparation B comprises at least one alkalizing agent in an amount of about 3 to about 70 wt. %.

5. Method according to claim 1, wherein preparation B comprises at least one complexing agent in an amount of about 0.1 to about 70 wt. %.

6. Method according to claim 1, wherein preparation C contains at least one bleaching agent in a quantity of 1 to 95, preferably 5 to 80 and in particular 20 to 50 wt. %.

7. Method according to claim 1, wherein at least two of the three times t₁, t₂ and t₃ differ from one another.

8. Method according to claim 1, wherein at least one of preparations A, B and C is added to a washing liquor at least one further time during the method.

9. Method according to claim 1 wherein the wash or rinse cycle comprises a main wash cycle, a prewash and/or rinse cycle.

10. Method according to claim 9 wherein the wash or rinse cycle comprises a prewash cycle, and at least a partial quantity m_{AK}, m_{BK} and/or m_{CK} of total quantities m_{A}, m_{B} and m_{C} of preparations A, B and C added during the method is added in the prewash cycle, each partial quantity comprising less than 50% of their total respective quantity.

11. Method according to claim 9 wherein the wash or rinse cycle comprises a rinse cycle, and at least a partial quantity m_{AK}, m_{BK} and/or m_{CK} of total quantities m_{A}, m_{B} and m_{C} of preparations A, B and C added during the method is added in the rinse cycle, each partial quantity comprising about 50% or less of their total respective quantity.

12. Method according to claim 1 wherein at least one of preparations A, B and C is liquid and has a viscosity (Brookfield LVT-II viscometer at 20 rpm and 20° C., spindle 3) of 5 to 1000 mPas, the addition of the preparations to the at least one washing liquor taking place from mutually separate water-insoluble containers in a movable dispensing and dosing system.

13. Method according to claim 12, wherein the method is a washing method in a discontinuously operating dishwashing machine and the water-insoluble containers each contain multiple dosages of preparations A, B and C necessary to wash one load of dishes under conventional operating conditions.

14. Combination product comprising a packaging and three preparations A, B and C contained separately from one another in the packaging,
wherein preparation A comprises about 0.01 to about 20 wt. % of at least one protease and optionally at least one further enzyme, at least one enzyme stabilizer, at least one polymer, at least one bleach activator, and/or at least one bleach catalyst,
wherein preparation B comprises about 3 to about 70 wt. % of at least one alkalizing agent and optionally at least one complexing agent and/or at least one polymer,
wherein preparation C comprises about 1 to about 95 wt. % of at least one bleaching agent and optionally at least one non-aqueous solvent, at least one bleach activator, and/or at least one bleach catalyst,
preparations A, B and C differing from one another in their compositions, at least one of preparations A, B and C containing at least one surfactant and at least one of preparations A and B being liquid.

15. Dispensing and dosing system comprising a combination product according to claim 14, wherein the system is a movable system having its own power source.
